(19) United States
(12) Patent Application Publication
(10) Pub. No.: US 2026/0281589 A1
(43) Pub. Date: Sep. 17, 2026

(54) IMAGE SENSOR, AND METHOD OF OPERATING IMAGE SENSOR

(71) Applicant: SAMSUNG ELECTRONICS CO., LTD., Suwon-si (KR)

(72) Inventors: Masamichi ITO, Suwon-si (KR); Daehee BAE, Suwon-si (KR); Minwoong SEO, Suwon-si (KR)

(73) Assignee: SAMSUNG ELECTRONICS CO., LTD., Suwon-si (KR)

(21) Appl. No.: 19/560,547

(22) Filed: Mar. 9, 2026

(30) Foreign Application Priority Data
Mar. 13, 2025 (KR) 10-2025-0032943

(51) Int. Cl. H04N 25/78; H04N 25/616; H04N 25/773

(52) U.S. Cl. CPC H04N 25/78; H04N 25/616; H04N 25/773

(57) ABSTRACT

An image sensor is provided. The image sensor includes: a pixel array with pixels. At least one of the pixels includes: a photo detecting circuit configured to output a pixel signal corresponding to a signal level and a reset level based on a received optical signal; an ADC configured to receive the pixel signal, generate a reset value and a signal value by converting the pixel signal into an analog-to-digital converted signal; and a clamping circuit configured to provide a clamping signal to the input terminal of the ADC during an auto-zero period; a clamping correction circuit configured to generate a corrected reset value by correcting the reset value provided from the pixel array based on a threshold value; and a digital CDS circuit configured to generate pixel data based on the corrected reset value and the signal value provided from the pixel array.

### CROSS-REFERENCE TO RELATED APPLICATION

This application is based on and claims priority under 35 U.S.C. § 119 to Korean Patent Application No. 10-2025-0032943, filed on Mar. 13, 2025, in the Korean Intellectual Property Office, the disclosure of which is incorporated by reference herein in its entirety.

### BACKGROUND

The present disclosure relates to an image sensor and a method of operating the image sensor, and more particularly, to an image sensor performing a clamping function and a method of operating the same.

An image sensor is a device that generates an image of an object by using a photoelectric conversion element that reacts according to the intensity of light reflected from the object. The generated image may be a two-dimensional image or a three-dimensional image. Recently, with the development of the computer industry and the communication industry, the demand for improved image sensors in electronic devices used in various environments such as digital cameras, camera recorders called camcorders, personal communication systems (PCS), game devices, security cameras, medical microcameras, and mobile phones is increasing. Image sensors are required to have high resolution and good noise characteristics for high-quality images.

### SUMMARY

One or more example embodiments provide an image sensor configured to prevent the occurrence of a sun spot in an image without a side effect and a method of operating the same.

One or more example embodiments provide an image sensor and a method of operating the image sensor.

According to an aspect of an example embodiment, an image sensor includes: a pixel array including a plurality of pixels arranged in a matrix, wherein at least one of the plurality of pixels includes: a photo detecting circuit configured to output a pixel signal corresponding to a signal level and a reset level based on a received optical signal; an analog-to-digital converter (ADC) including an input terminal configured to receive the pixel signal, wherein the ADC is configured to generate a reset value and a signal value by converting the pixel signal into an analog-to-digital converted signal; and a clamping circuit configured to provide a clamping signal to the input terminal of the ADC during an auto-zero period in which the ADC performs an auto-zero operation; a clamping correction circuit configured to generate a corrected reset value by correcting the reset value provided from the pixel array based on a threshold value; and a digital correlated double sampling (CDS) circuit configured to generate pixel data based on the corrected reset value and the signal value provided from the pixel array.

According to another aspect of an example embodiment, an image sensor includes: a pixel array including a plurality of pixels arranged in a matrix, wherein at least one of the plurality of pixels includes a photo detecting circuit configured to output a pixel signal corresponding to a signal level and a reset level based on a received optical signal, an ADC configured to generate a reset value and a signal value by converting the pixel signal into an analog-to-digital converted signal, and a clamping circuit that provides a clamping signal to the ADC, and wherein the pixel signal and the clamping signal are received through an input terminal of the ADC; and a clamping correction circuit configured to, based on the reset value received from the pixel array being greater than or equal to a first threshold value and less than a second threshold value, output the first threshold value as a corrected reset value, and based on the reset value being greater than or equal to the second threshold value, output, as the corrected reset value, a negative reset value corresponding to a minimum negative value representable by a reset code format of the corrected reset value.

According to another aspect of an example embodiment, a method of operating an image sensor including a plurality of pixels configured to sense an optical signal, wherein at least one of the plurality of pixels includes a photo detecting circuit, an analog-to-digital converter (ADC), and a clamping circuit, includes: applying, by the photo detecting circuit, a first power supply voltage to a floating diffusion node in a first period to reset the floating diffusion node; performing, by the ADC, an auto-zero operation in a second period; providing, by the clamping circuit, a clamping voltage to an input terminal of the ADC in a third period including the second period; converting, by the ADC, a pixel signal to a reset value, wherein the pixel signal is received from the photo detecting circuit through the input terminal in a fourth period after the third period; converting, by the ADC, the pixel signal to a signal value, in a fifth period after the third period; correcting, by the ADC, the reset value based on a first threshold value to generate a corrected reset value; and generating, by the ADC, pixel data by subtracting the corrected reset value from the signal value.

According to another aspect of an example embodiment, an image sensor includes a pixel array including a plurality of pixels arranged in a matrix, and a pre-processing circuit configured to receive a reset value and a signal value from the pixel array and generate pixel data based on the reset value and the signal value, wherein each of the plurality of pixels includes a photo detecting circuit that outputs a pixel signal corresponding to a signal level and a reset level based on a received optical signal, an ADC that generates the reset value and the signal value by converting the pixel signal received through an input terminal into an analog-to-digital converted signal, and a clamping circuit that provides a clamping signal to the input terminal during an auto-zero period in which the ADC performs an auto-zero operation, wherein a level of the clamping signal may be higher than the reset level.

According to various example embodiments of the inventive concept, an image signal processor performing image processing on image data including a plurality of pieces of pixel data provided from the pre-processing circuit may be further included.

### BRIEF DESCRIPTION OF DRAWINGS

The above and other aspects and features of the present disclosure will be more clearly understood from the following description of example embodiments, taken in conjunction with the accompanying drawings, in which:

FIG. 1 is a schematic block diagram of an image sensor according to an example embodiment;

FIGS. 2A and 2B are block diagrams schematically illustrating respective pixels according to example embodiments;

FIG. 3 is a block diagram illustrating a comparator provided in a pixel and a connection relationship of the comparator according to an example embodiment;

FIG. 4 is a timing diagram of a sampling period of a pixel according to an example embodiment;

FIG. 5 is a graph illustrating a clamping correction method performed by a clamping correction circuit according to an example embodiment;

FIG. 6 is a flowchart illustrating a correcting method of a clamping correction circuit according to an example embodiment;

FIG. 7 is a timing diagram of a pixel in which no clamping is performed according to a first comparative example;

FIG. 8A is a timing diagram of a pixel in which clamping is performed during a reset ADC period according to a second comparative example; and FIG. 8B is a timing diagram showing a side effect when clamping is performed according to FIG. 8A;

FIG. 9 is a timing diagram of a sampling period of a pixel according to an example embodiment;

FIG. 10 is a timing diagram of a sampling period of a pixel according to an example embodiment;

FIG. 11 is a timing diagram of a sampling period of a pixel according to an example embodiment;

FIG. 12 is a circuit diagram illustrating an image sensor according to an example embodiment;

FIG. 13 is a flowchart illustrating a method of operating an image sensor according to an example embodiment;

FIGS. 14A and 14B are perspective views illustrating respective stack structures of image sensors according to example embodiments; and

FIG. 15 is a block diagram illustrating an electronic device including an image sensor according to an example embodiment.

### DETAILED DESCRIPTION

Example embodiments will be described with reference to the accompanying drawings.

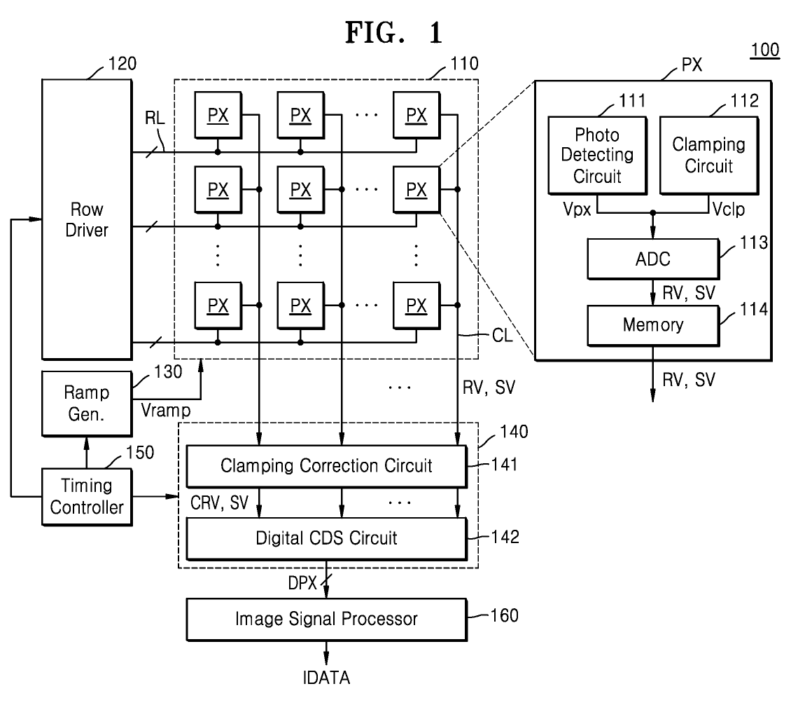

FIG. 1 is a schematic block diagram of an image sensor according to an example embodiment.

An image sensor 100 may generate image data IDATA based on a received optical signal (image information). The image sensor 100 may be mounted in an electronic device having an imaging or an optical sensing function. For example, the image sensor 100 may be mounted on electronic devices such as cameras, smartphones, wearable devices, Internet of Things (IoT) devices, tablet personal computers (tablet PCs), personal digital assistants (PDAs), portable multimedia players (PMPs), navigation, drones, advanced drivers assistance systems (ADASs), and the like. In addition, the image sensor 100 may be mounted in an electronic device provided as a component in vehicles, furniture, manufacturing facilities, doors, various measuring devices, and the like.

Referring to FIG. 1, the image sensor 100 may include a pixel array 110, a row driver 120, a ramp signal generator (e.g., ramp signal generation circuit) 130, a pre-processing circuit 140, a timing controller (e.g., timing control circuit) 150, and an image signal processor 160. The image sensor 100 may further include other components, for example, a voltage generator that generates various voltages (e.g., control voltages, bias voltages, etc.) used in the image sensor 100, and an interface circuit for transmitting image data IDATA to an external processor. The image sensor 100 may include a semiconductor chip or a semiconductor module.

The pixel array 110 may include a plurality of pixels PX arranged in a matrix, and a plurality of row lines RL and a plurality of column lines CL connected to the plurality of pixels PX.

Each of the plurality of pixels PX may detect (or sense) an optical signal (e.g., light) received from the outside and generate an electrical signal (e.g., a pixel signal Vpx) corresponding to the sensed optical signal. Each of the plurality of pixels PX may convert the pixel signal Vpx into a digital signal (e.g., a reset value RV and a signal value SV), and output the digital signal. Each of the plurality of pixels PX may receive control signals through a corresponding row line RL among the plurality of row lines RL and output the reset value RV and the signal value SV through a corresponding column line CL among the plurality of column lines CL.

Each of the plurality of pixels PX may sense light in a specific spectrum range. For example, the plurality of pixels PX may include red pixels that convert an optical signal in a red spectrum range into an electrical signal, green pixels that convert an optical signal in a green spectrum range into an electrical signal, and blue pixels that convert an optical signal in a blue spectrum range into an electrical signal.

In an example embodiment, each of the plurality of pixels PX may include a photo detecting circuit 111, a clamping circuit 112, an analog-to-digital converter (ADC) (e.g., ADC circuit) 113, and a memory 114.

The photo detecting circuit 111 may include a photo sensing element (or a photo detecting element), and may convert an optical signal received from the outside into an electrical signal, that is, a pixel signal (e.g., a pixel voltage), which is an analog signal. The pixel signal may include a reset level according to the reset operation of the pixel PX, and may include a signal level according to a photo detection operation of the pixel PX. For example, the photo sensing element may include a photodiode, an organic photo film, a phototransistor , a port gate, a pinned photodiode, or the like. Hereinafter, a photodiode as a photo sensing element will be described as an example.

The ADC 113 may convert a pixel signal output from the photo detecting circuit 111 into a digital signal. The ADC 113 may perform analog-to-digital conversion of pixel signals according to a correlated double sampling (CDS) technique. The ADC 113 may analog-to-digital convert the reset level of the pixel signal Vpx to a reset value RV (or a reset code) by using a ramp signal Vramp (hereinafter, referred to as a reset ADC operation), and analog-to-digital convert the signal level of the pixel signal Vpx to a signal value SV (or a signal code) by using the ramp signal Vramp (hereinafter, referred to as a signal ADC operation). A period during which the reset ADC operation is performed may be referred to as a reset ADC period, and a period during which the signal ADC operation is performed may be referred to as a signal ADC period. The reset value RV and the signal value SV may be stored in the memory 114.

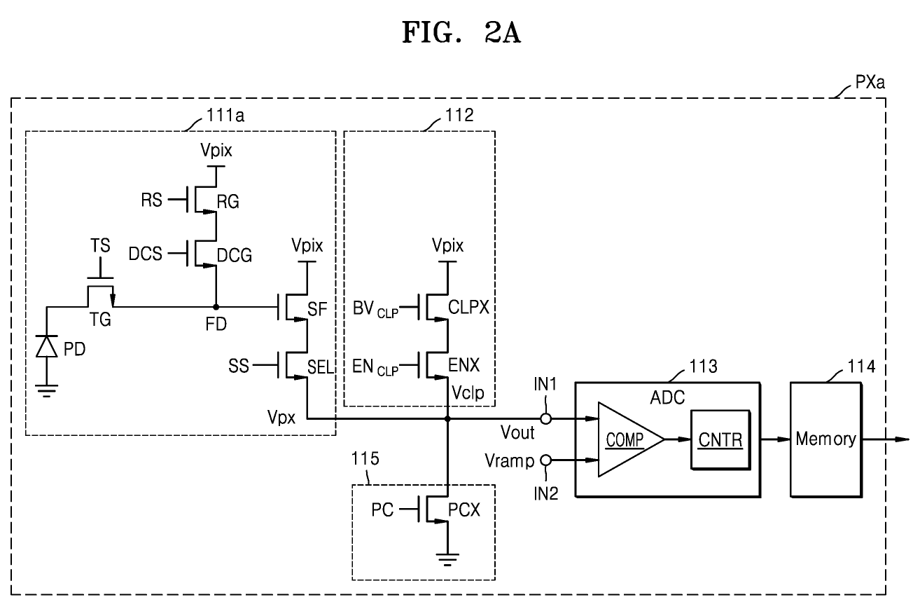

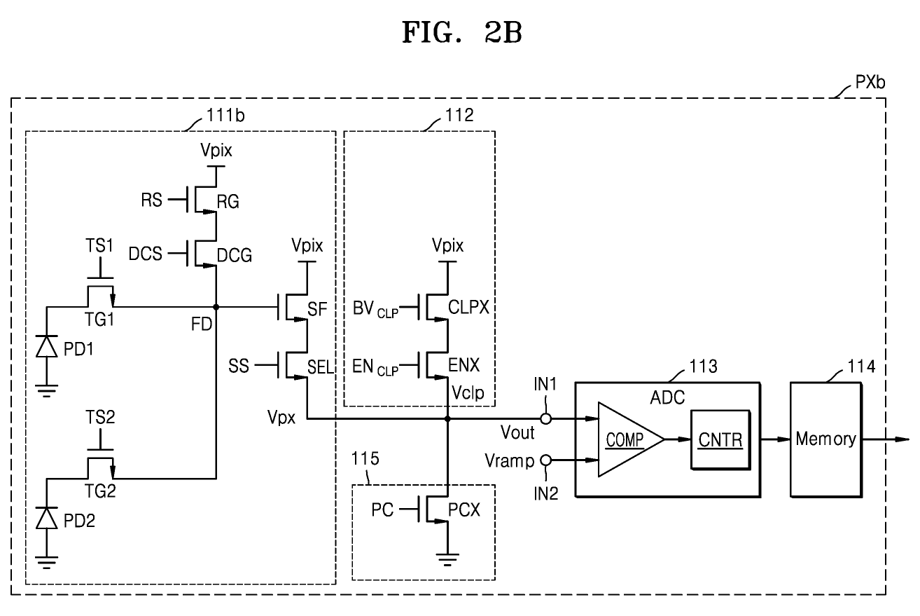

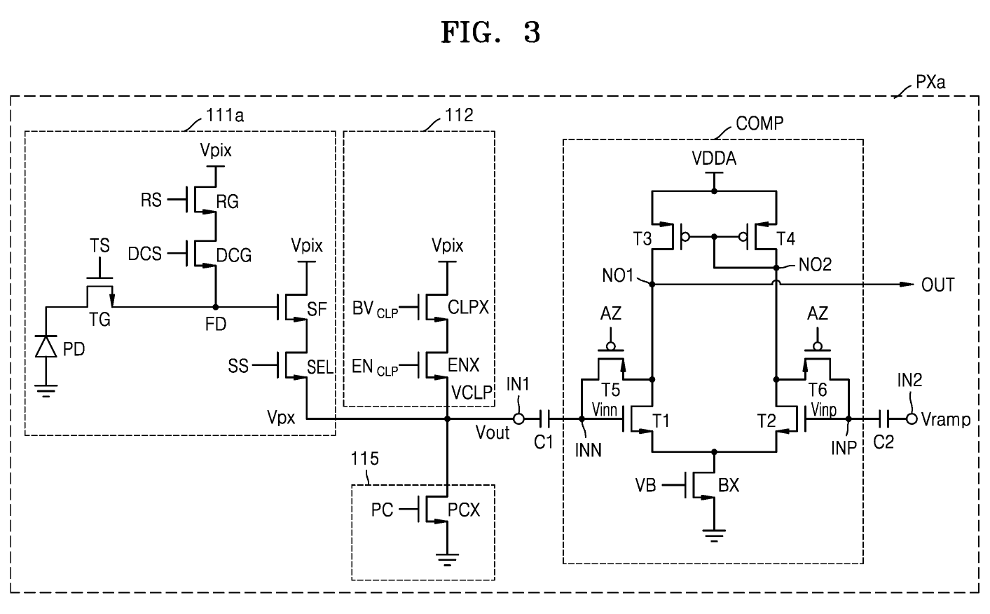

The ADC 113 may perform an auto-zero operation in an auto-zero period before conversion of the pixel signal Vpx. The ADC 113 may be reset by the auto-zero operation. For example, the offset of the comparator (e.g., COMP in FIG. 2A) provided in the ADC 113 is removed, and a voltage level of an input node of the comparator may be set to an auto-zero level. The auto-zero operation may be performed based on an input signal of the ADC 113 received in the auto-zero period. The auto-zero level may become a reference for analog-to-digital conversion during the reset ADC operation and the signal ADC operation.

The clamping circuit 112 may provide a clamping signal (e.g., a clamping voltage) Vclp to the ADC 113. The clamping circuit 112 according to an example embodiment is activated in the auto-zero period (or a clamping-on period including the auto-zero period), and may provide a clamping signal Vclp to the input terminal of the ADC 113 in the auto-zero period. The clamping circuit 112 may be deactivated during the reset ADC period and the signal ADC period. For example, during the reset ADC period and the signal ADC period, provision of the clamping signal Vclp to the input terminal of the ADC 113 may be blocked.

When the intensity of light incident on the pixel PX is excessively large, charges generated by the photodiode may flow into a floating diffusion node FD after the floating diffusion node FD has been reset during a sampling period of the pixel PX, and thus the reset level of the pixel PX may be excessively lowered. When the auto-zero operation of the ADC 113 is performed based on an excessively low reset level, black-looking sun spots may occur in image data IDATA generated by the image sensor 100. For example, when the image sensor 100 photographs a subject of a high light intensity such as the sun, sun spots may occur.

In order to prevent (or remove) the occurrence of sun spots, the clamping circuit 112 may provide a clamping signal Vclp to the ADC 113 in the auto-zero period. In an example embodiment, the ADC 113 may typically perform an auto-zero operation based on the reset level included in the pixel signal Vpx, but when the reset level is excessively low (e.g., when the reset level is lower than the level of the clamping signal Vclp), the ADC 113 may perform an auto-zero operation based on the clamping signal Vclp.

In example embodiments, the level of the clamping signal Vclp may be higher than the normal reset level of the pixel signal Vpx, and the photo detecting circuit 111 may block the output of the pixel signal Vpx including the reset level in the auto-zero period. Accordingly, the ADC 113 may perform an auto-zero operation based on the clamping signal Vclp.

Because the output and output blocking of the clamping signal Vclp of the clamping circuit 112 may affect the reset level and signal level of the pixel signal Vpx, the clamping circuit 112 may be deactivated during the reset ADC period and the signal ADC period.

In this way, analog clamping in which the clamping circuit 112 provides the clamping signal Vclp to the ADC 113 in the auto-zero period may be performed in the pixel PX.

The image sensor 100 may operate according to a global shuttering method. According to the global shuttering method, multiple pixels PX may be reset simultaneously during a global reset period (e.g., charge remaining in the photodiode is removed), and the multiple pixels PX may then simultaneously receive an optical signal during an accumulation period (or, an exposure period), and sample a pixel signal Vpx according to the optical signal during a subsequent sampling period (or, a global signal dumping period). The sampled pixel signals, for example, the reset value RV and the signal value SV, may be stored in the memory 114 provided in each of the plurality of pixels PX and then output during a readout period. During the readout period, the pixel array 110 may sequentially output reset values RVs and signal values SVs in a row unit, and the reset values RVs and signal values SVs may be provided to the clamping correction circuit 141.

The row driver 120 may drive the pixel array 110. The row driver 120 may output, to the pixel array 110, pixel control signals for driving a plurality of pixels PX. For example, pixel control signals may include a reset control signal (RS of FIG. 2A), a transfer control signal (TS of FIG. 2A), a selection signal (SEL of FIG. 2A), a conversion control signal (DCS of FIG. 2A), and a clamping enable signal (EN_{CLP} of FIG. 2A).

The ramp signal generator 130 may generate a ramp signal Vramp and provide the ramp signal Vramp to the pixel array 110. The ramp signal Vramp is provided to the ADC 113 provided in each of the plurality of pixels PX, and may be used as a reference signal to be compared with the pixel signal Vpx. In an example embodiment, the ramp signal Vramp may be a signal of which the level decreases or increases regularly (e.g., an increase/decrease signal with a constant or linear slope).

The pre-processing circuit 140 may receive the reset value RV and the signal value SV, and generate pixel data DPX (which may be referred to as a pixel value) based on the reset value RV and the signal value SV. The pre-processing circuit 140 may provide a plurality of pieces of pixel data DPX to the image signal processor 160. The pre-processing circuit 140 may include a clamping correction circuit 141 and a digital CDS circuit 142.

The clamping correction circuit 141 may correct the reset value RV based on a threshold value to generate (and output) a corrected reset value CRV. In an example embodiment, when the reset value RV is greater than or equal to a first threshold value and less than a second threshold value that is greater than the first threshold value, the clamping correction circuit 141 may generate and output the first threshold value as a corrected threshold value. When the reset value RV is greater than or equal to the second threshold value, the clamping correction circuit 141 may generate and output a minimum negative reset value representable by a reset code format as a corrected reset value. When the reset value RV is less than the first threshold value, the clamping correction circuit 141 may not correct the reset value RV. For example, when the reset value RV is less than the first threshold value, the clamping correction circuit 141 may output the reset value RV as the corrected reset value CRV.

The digital CDS circuit 142 may receive the signal value SV and the corrected reset value CRV, and subtract the corrected reset value CRV from the signal value SV to generate pixel data DPX. Accordingly, a value obtained by removing the offset or noise of the pixel PX from the signal value SV may be generated as pixel data DPX.

In this way, the pre-processing circuit 140 may correct the reset value RV equal to or greater than the first threshold value and perform digital clamping to generate pixel data DPX based on the corrected reset value RV.

The timing controller 150 may control overall operations of the image sensor 100. For example, the timing controller 150 may control the operation timing of the image sensor 100 based on control information received from an external processor. For example, the timing controller 150 may provide control signals for controlling the operation timing to each of the row driver 120, the ramp signal generator 130, and the pre-processing circuit 140.

The image signal processor 160 (which may be referred to as an image signal processing circuit) receives a plurality of pieces of pixel data DPX from the pre-processing circuit 140 as input image data and may perform image processing on the input image data. For example, the image signal processor 160 may change the data pattern of the input image data (e.g., change to RGB pattern) or perform image processing such as gain adjustment, binning, downsizing, remosaic processing, image quality compensation, and high dynamic range (HDR) processing. For example, the image quality compensation may include signal processing such as black level compensation (or dark level compensation), lens shading compensation, crosstalk compensation, and bad pixel compensation.

The image data IDTA processed by the image signal processor 160 may be transmitted to an external processor. For example, the external processor may be a main processor of an electronic device on which the image sensor 100 is mounted. For example, the external processor may be an application processor of a mobile terminal.

The image sensor 100 may further include the interface circuit, and the interface circuit may transmit image data IDATA to an external processor according to a data communication method based on a set interface, for example, a mobile industry processor interface (MIPI).

As described above, in the image sensor 100 according to an example embodiment, each of the plurality of pixels PX may include the clamping circuit 112, and the clamping circuit 112 may perform analog clamping to provide the clamping signal Vclp to the ADC 113 during the auto-zero period of the ADC 113. In addition, when the reset value RV is greater than or equal to the first threshold value, the pre-processing circuit 140 may perform digital clamping that corrects the reset value RV and generates pixel data DPX based on the corrected reset value CRV. Accordingly, even if the intensity of the optical signal received by the pixel is excessive, it is possible to prevent the occurrence of sun spots in the image data IDATA (or to remove sun spots).

Furthermore, according to the analog clamping described above, the clamping circuit 112 is disabled during the reset ADC period and the signal ADC period. Accordingly, the output and the blocking of the clamping signal Vclp may be prevented from affecting the pixel signal Vpx during the reset ADC period and the signal ADC period. Therefore, a dark offset may be prevented from occurring in the image data IDATA generated under a dark condition (or a very weak illumination condition), or fixed pattern noise (FPN) may be prevented from occurring in the image data. Accordingly, the image quality of the image data IDATA may be improved.

FIGS. 2A and 2B are diagrams schematically illustrating respective pixels according to example embodiments. Each of the pixels PXa and PXb of FIGS. 2A and 2B may be applied to the pixel PX of FIG. 1.

Referring to FIG. 2A, the pixel PXa may include a photo detecting circuit 111a, a clamping circuit 112, an ADC 113, a memory 114, and a current source 115.

The photo detection circuit 111a may include a photodiode PD and a plurality of transistors, and the plurality of transistors may include a transfer transistor TG (which may be referred to as a transmission transistor), a reset transistor RG, a source follower transistor SF (which may be referred to as a driving transistor DX), and a selection transistor SEL, and may further include a conversion gain control transistor DCG. The transfer transistor TG, the reset transistor RG, the conversion gain control transistor DCG, and the selection transistor SEL may be turned on and off in response to a transfer control signal TS, a reset control signal RS, a conversion gain control signal DCS, and a selection signal SS provided from the row driver (e.g., 120 of FIG. 1).

The photodiode PD may generate and accumulate electric charges according to the intensity of received light. For example, the photodiode PD may generate a charge, that is, a negative charge, an electron, and a positive charge, in proportion to the amount of incident light.

The reset transistor RG may reset a floating diffusion node FD in response to the reset control signal RS. In the reset period (e.g., a reset period during a sampling period), the reset transistor RG and the conversion gain control transistor DCG may be turned on in response to the activation level of the reset control signal RS and the activation level of the conversion gain control signal DCS, respectively, and a pixel power voltage Vpix may be applied to the floating diffusion node FD. Charges remaining in the floating diffusion node FD may be removed, and a voltage level (e.g., a reset level) of the floating diffusion node FD may be the same as or similar to the voltage level of the pixel power voltage Vpix.

The transfer transistor TG connected between the photodiode PD and the floating diffusion node FD may be turned on in response to the active level of the transfer control signal TS to transfer the charges accumulated in the photodiode PD to the floating diffusion node FD. Charges received through the transfer transistor TG may be accumulated in the floating diffusion node FD. A capacitor (or a parasitic capacitor) may be formed in the floating diffusion node FD, and charges may be accumulated in the parasitic capacitor.

The voltage (potential) of the floating diffusion node FD may correspond to the accumulated charges. In this case, a ratio at which the charges accumulated in the floating diffusion node FD are converted into a voltage (e.g., the voltage of the floating diffusion node FD) may be referred to as a conversion gain. The capacitance of the floating diffusion node FD may be changed, and the conversion gain may be inversely proportional to the capacitance.

The capacitance of the floating diffusion node FD may decrease when the conversion gain transistor DCG is turned off, and may increase when the conversion gain transistor DCG is turned on. When the capacitance of the floating diffusion node FD increases, the conversion gain decreases, and when the capacitance of the floating diffusion node FD decreases, the conversion gain may increase. Therefore, a state in which the conversion gain transistor DCG is turned off may be referred to as a high conversion gain (HCG) mode, and a state in which the conversion gain transistor DCG is turned on may be referred to as a low conversion gain (LCG) mode.

The source follower transistor SF may output the pixel signal Vpx corresponding to the voltage (potential) of the floating diffusion node FD. When the selection transistor SEL is turned on, the source follower transistor SF may operate as a source follower based on a bias current generated by the current source 115. The source follower transistor SF may output the voltage of the floating diffusion node FD as a pixel signal Vpx. When the selection transistor SEL is turned off, the source follower transistor SF cannot operate, and thus the pixel signal Vpx is not output. For example, the output of the photo detecting circuit 111a may be blocked.

After the reset transistor RG is turned on to reset the floating diffusion node FD, a pixel signal Vpx corresponding to a voltage (e.g., a reset level) of the floating diffusion node FD may be output. After the transfer transistor TG is turned on and the charge generated by the photodiode PD is transferred and accumulated to the floating diffusion node FD, a pixel signal Vpx corresponding to the voltage (e.g., signal level) of the floating diffusion node FD may be output.

The clamping circuit 112 may include a clamping transistor CLPX and a clamping enable transistor ENX, and the clamping transistor CLPX and the clamping enable transistor ENX may operate in response to a clamping bias voltage BV_{CLP} and a clamping enable signal EN_{CLP}, respectively. The clamping enable signal EN_{CLP} may be provided from the row driver 120 (see FIG. 1) or may be provided from a separate control circuit. The clamping bias voltage BV_{CLP} may be provided from a voltage generator provided in the image sensor (100 of FIG. 1).

When the clamping enable transistor ENX is turned on, the clamping circuit 112 is enabled and when the clamping enable transistor ENX is turned off, the clamping circuit 112 may be disabled. When the clamping enable transistor ENX is turned on, the clamping transistor CLPX may generate and output a clamping signal Vclp based on the clamping bias voltage BV_{CLP}. In an example embodiment, the clamping transistor CLPX may operate as a source follower, and may output the clamping bias voltage BV_{CLP} as a clamping signal Vclp.

As described with reference to FIG. 1, the clamping circuit 112 may be activated during the auto-zero period of the ADC 113 to provide the clamping signal Vclp to the ADC 113. For example, in the auto-zero period, the clamping enable transistor ENX may be turned on to output the clamping signal Vclp to a first input terminal IN1 of the ADC 113. The clamping circuit 112 may be deactivated during the reset ADC period and the signal ADC period. For example, the clamping enable transistor ENX may be turned off during the reset ADC period and the signal ADC period.

In an example embodiment, the level of the clamping signal Vclp may be lower than the normal reset level of the pixel signal Vpx (e.g., a reset level when the intensity of light incident on the pixel PX is not excessively large). In an example embodiment, a level of the clamping signal Vclp may be higher than a normal reset level of the pixel signal Vpx.

The current source 115 may generate a bias current. The current source 115 may include a precharge transistor PCX, and the precharge transistor PCX may generate a bias current based on a precharge voltage PC.

In an example embodiment, as shown, the transistors provided in the photo detecting circuit 111a, the clamping circuit 112, and the current source 115 may be implemented as NMOS transistors (e.g., N-type metal oxide semiconductor field effect transistors (MOSFETs). However, example embodiments are not limited thereto, and transistors may be implemented as PMOS transistors (e.g., P-type MOSFETs).

The ADC 113 may include a comparator (i.e., comparator circuit) COMP and a counter (i.e., counter circuit) CNTR. The comparator COMP receives an output voltage Vout through the first input terminal IN1, and the output voltage Vout may be one of a pixel signal Vpx and a clamping signal Vclp provided to the first input terminal IN1. The comparator COMP may receive a ramp signal Vramp through a second input terminal IN2. The comparator COMP may output a first comparison result signal by comparing the reset level of the pixel signal Vpx with the ramp signal Vramp in the reset ADC period, and may output a second comparison result signal by comparing the signal level of the pixel signal Vpx with the ramp signal Vramp in the signal ADC period.

In the auto-zero period, a pixel signal Vpx having a reset level from the photo detecting circuit 111a and a clamping signal Vclp from the clamping circuit 112 may be provided to the first input terminal IN1, and an auto-zero operation of the ADC 113 may be performed based on the reset level of the pixel signal Vpx or the level of the clamping signal Vclp.

The counter CNTR may generate a reset value RV based on the first comparison result signal and generate a signal value SV based on the second comparison result signal. In an example embodiment, the counter CNTR may receive a clock signal, count a first determination time point at which the level of the first comparison result signal shifts from a low level to a high level (or from a high level to a low level) from a first reference time point based on the clock signal, and generate a counted value as a reset value RV. In addition, based on the clock signal, a second determination point at which the level of the second comparison result signal shifts from a second reference point may be counted, and a counted value may be generated as a signal value SV. In an example embodiment, the counter CNTR may receive a counting code (e.g., a gray code), generate a reset value RV by latching a code value at the first determination time when the level of the first comparison result signal is shifted, and generate a signal value SV by latching the code value at the second determination time when the level of the second comparison result signal is shifted.

The memory 114 may store the reset value RV and the signal value SV. The reset value RV and the signal value SV temporarily stored in the memory 114 may be provided to the pre-processing circuit 140 (see FIG. 1).

In an example embodiment, the photo detecting circuit 111a is shown to include one photodiode PD and one transfer transistor TG. However, example embodiments are not limited thereto, and as shown in FIG. 2B, the photo detecting circuit 111b may include a plurality of photodiodes and a plurality of transfer transistors corresponding to the plurality of photodiodes.

Referring to FIG. 2B, the pixel PXb may include a photo detecting circuit 111b, a clamping circuit 112, an ADC 113, a memory 114, and a current source 115. The structure and operation of the clamping circuit 112, the ADC 113, the memory 114, and the current source 115 are the same as described with reference to FIG. 2A.

The photo detecting circuit 111b may include a first photodiode PD1 and a second photodiode PD2, and a first transfer transistor TG1 connected to the first photodiode PD1 and a second transfer transistor TG2 connected to the second photodiode PD2. The first transfer transistor TG1 and the second transfer transistor TG2 may be turned on and off in response to a first transfer control signal TS1 and a second transfer control signal TS2, respectively. The first transfer transistor TG1 may be turned on to transfer the charges accumulated in the first photodiode PD1 to the floating diffusion node FD, and the second transfer transistor TG2 may be turned on to transfer the charges accumulated in the second photodiode PD2 to the floating diffusion node FD. The first transfer transistor TG1 and the second transfer transistor TG2 may be turned on simultaneously or at different time points.

Operations of the reset transistor RG, the conversion gain control transistor DCG, the selection transistor SEL, and the source follower transistor SF are the same as described with reference to FIG. 2A.

The first photodiode PD1 and the second photodiode PD2 and the first transfer transistor TG1 and the second transfer transistor TG2 respectively corresponding to the first photodiode PD1 and the second photodiode PD2 may share the floating diffusion node FD, the reset transistor RG, the conversion gain control transistor DCG, the selection transistor SEL, and the source follower transistor SF.

Pixels applicable to the pixel PX of FIG. 1 have been described as examples with reference to FIGS. 2A and 2B. However, example embodiments are not limited thereto, and one of the pixels of various structures may be implemented as a pixel PX. For example, the pixel PX may not include the conversion gain control transistor DCG connected between the reset transistor RG and the floating diffusion node FD. For example, the photo detecting circuit 111 of FIG. 1 may include a larger number of transistors. For example, a separate conversion gain control transistor, a separate driving transistor, and a separate selection transistor may be connected to the second transfer transistor TG2 of FIG. 2B. For example, the first photodiode PD1 and the second photodiode PD2 may have different sizes.

FIG. 3 is a diagram illustrating a comparator provided in a pixel and a connection relationship of the comparator according to an example embodiment. For convenience of description, the photo detecting circuit 111a, the clamping circuit 112, and the current source 115 are shown together.

Referring to FIG. 3, the comparator COMP may be implemented as an operational transconductance amplifier (OTA). However, example embodiments are not limited thereto, and the comparator COMP may be implemented as a circuit having a differential input pair such as an operational amplifier and a differential amplifier.

The comparator COMP may include first to sixth transistors T1 to T6 and a bias transistor BX, and may operate based on an analog power supply voltage VDDA. The level of the analog power supply voltage VDDA may be the same as or different from the level of a pixel power supply voltage Vpix.

The bias transistor BX and the first and second transistors T1 and T2 may be implemented as NMOS transistors, and the third to sixth transistors T3 to T6 may be implemented as PMOS transistors. However, example embodiments are not limited thereto, and the bias transistor BX and the first and second transistors T1 and T2 may be implemented as PMOS transistors, and the third to sixth transistors T3 to T6 may be implemented as NMOS transistors.

The bias transistor BX may generate a bias current of the comparator COMP based on the bias voltage VB. The first and second transistors T1 and T2 may receive an output voltage Vout (e.g., a pixel signal Vpx or a clamping signal Vclp) and a ramp signal Vramp through a first capacitor C1 and a second capacitor C2, respectively. The third and fourth transistors T3 and T4 may operate as load stages.

The comparator COMP may compare the pixel signal Vpx with the ramp signal Vramp, and output a comparison result signal OUT based on the comparison. When a voltage level applied to a first input node INN based on the pixel signal Vpx is lower than a voltage level applied to a second input node INP based on the ramp signal Vramp, the comparator COMP may output the comparison result signal OUT of logic high (or logic low) through a first output node NO1, and when the voltage level applied to the first input node INN is greater than or equal to the voltage level applied to the second input node INP, the comparator COMP may output the comparison result signal OUT of logic low (or logic high) through the first output node NO1.

The fifth and sixth transistors T5 and T6 may be turned on and turned off in response to the auto-zero signal AZ, and in the auto-zero period, the fifth and sixth transistors T5 and T6 may be turned on in response to the auto-zero signal AZ of the active level to perform the auto-zero operation. The fifth and sixth transistors T5 and T6 may be turned on to connect the first input node INN with the first output node NO1 and connect the second input node INP with the second output node NO2, respectively. The voltage levels of the first input node INN, the second input node INP, the first output node NO1, and the second output node NO2 may be the same as the auto-zero level.

Accordingly, the offset of the comparator COMP may be removed, and the difference between the auto-zero level of the first input node INN and the voltage level (e.g., the level of the output voltage Vout) of the first input terminal IN1 may be stored in the first capacitor C1, and the difference between the auto-zero level of the second input node INP and the level of the ramp signal Vramp may be stored in the second capacitor C2. Thereafter, during the reset ADC period and the signal ADC period, the voltage level of the first input node INN may change according to a change in the level of the output voltage Vout (e.g., the pixel voltage Vpx) received through the first input terminal IN1, and the voltage level of the second input node INP may change according to a change in the level of the ramp signal Vramp.

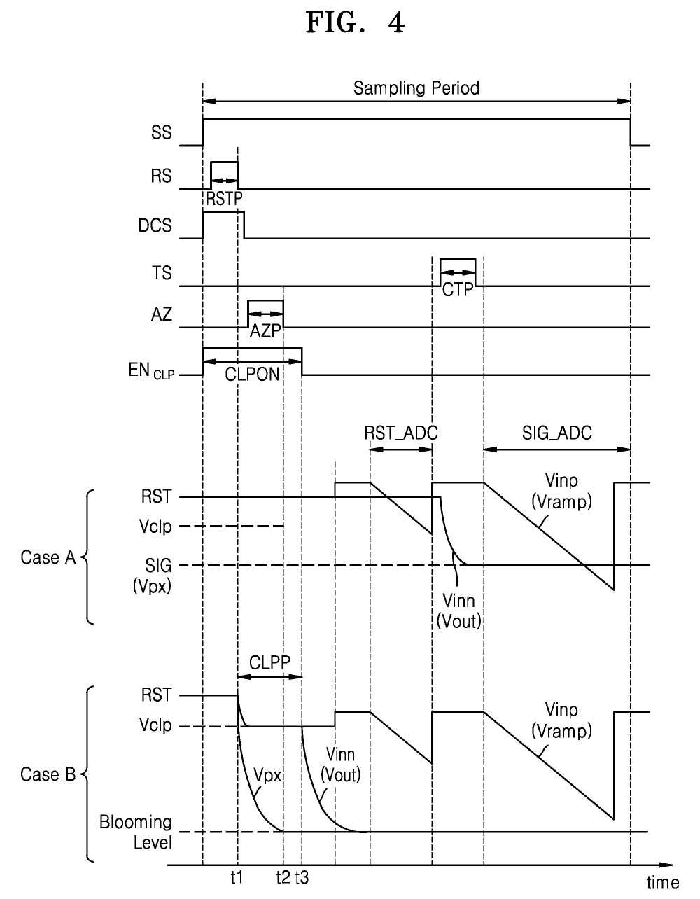

FIG. 4 is a timing diagram of a sampling period of a pixel according to an example embodiment.

FIG. 4 shows waveforms of pixel control signals applied to the pixel PXa of FIG. 3 during the sampling period, in which voltage waveforms of input nodes of the comparator COMP are shown. Case A represents the voltage waveforms of the comparator COMP in normal light intensity conditions, and Case B represents the voltage waveforms of the comparator COMP in high light intensity conditions (e.g., when the intensity of light incident on the pixel PX is excessively large). Description will be made with reference to FIGS. 3 and 4 together. Here, the logic high (high level) of the pixel control signals represents an active level to turn on the corresponding transistor, and the logic low (low level) represents an inactive level to turn off the corresponding transistor.

During the sampling period, the selection signal SS may be at a logic high level and the selection transistor SEL may be turned on. The photo detecting circuit 111a may output a pixel signal Vpx. The pixel signal Vpx may be provided to the first input terminal IN1.

The floating diffusion node FD may be reset when the reset transistor RG applies the pixel power voltage Vpix to the floating diffusion node FD during a reset period RSTP in which the reset control signal RS and the conversion gain control signal DCS have active levels.

The auto-zero operation may be performed during the auto-zero period AZP in which the auto-zero signal AZ has an active level. The auto-zero period AZP may be after the reset period RSTP or may overlap the reset period RSTP, and the end time point (e.g., t2) of the auto-zero period AZP may be after the end time point (e.g., t1) of the reset period RSTP.

The clamping circuit 112 may output the clamping signal Vclp during the clamping-on period CLPON in which the clamping enable signal EN_{CLP} has an active level. The clamping signal Vclp may be provided to the first input terminal IN1. The clamping-on period CLPON may overlap the auto-zero period AZP and/or the reset period RSTP, and the end time (e.g., t3) of the clamping-on period CLPON may be the same as the end time (e.g., t2) of the auto-zero period AZP or may be after the end time of the auto-zero period AZP. The clamping-on period CLPON does not overlap either of the reset ADC period RST_ADC and the signal ADC period SIG_ADC.

During the clamping-on period CLPON, both the clamping signal Vclp and the pixel signal Vpx are provided to the first input terminal IN1, and according to the Winner Take All scheme, the voltage level (e.g., the level of the output voltage Vout) of the first input terminal IN1 is determined according to the signal of the higher level of the levels of the clamping signal Vclp and the pixel signal Vpx.

In a normal light intensity condition (Case A), the reset level (hereinafter, referred to as the normal reset level RST) of the pixel signal Vpx may be higher than the level of the clamping signal Vclp, and the normal reset level RST may be set to the level of the output voltage Vout. For example, the pixel signal Vpx may be applied to the first input node INN of the comparator COMP through the first capacitor C1. The auto-zero operation of the comparator COMP may be performed based on the reset level of the pixel signal Vpx. During the auto-zero period AZP, the voltage Vinn of the first input node INN1 (hereinafter, referred to as a first input node voltage) and the voltage Vinp of the second input node (hereinafter, referred to as a second input node voltage) become the same as the auto-zero level, and the difference between the normal reset level RST and the auto-zero level of the pixel signal Vpx may be stored in the first capacitor C1.

After the offset is added to the ramp signal Vramp, the level of the ramp signal Vramp may decrease to a predetermined slope in the reset ADC period RST_ADC. A change in the level of the ramp signal Vramp is reflected in the second input node voltage Vinp. The level of the comparison result signal OUT (e.g., the first comparison result signal) output from the comparator COMP may be shifted at a time point (e.g., a first determination time point) when the voltage level of the second input node voltage Vinp becomes the same as the voltage level of the first input node voltage Vinn. The counter CNTR of FIG. 2A may generate a reset value (or reset code) by counting the comparison result signal OUT output during the reset ADC period RST_ADC.

An offset may be added to the ramp signal Vramp again, and the transfer control signal TS may toggle. The transfer transistor TG may be turned on during the charge transfer period CTP in which the transfer control signal TS has an active level and thus may transfer the charges accumulated in the photodiode PD to the floating diffusion node FD. As electric charges are accumulated in the floating diffusion node FD, the voltage of the floating diffusion node FD may decrease. The voltage (signal level) of the floating diffusion node FD may be output to the first input terminal IN1 as the pixel signal Vpx, and the pixel signal Vpx having a signal level SIG may be provided to the comparator COMP as the output voltage Vout. As the voltage level of the pixel signal Vpx decreases, the level of the first input node voltage Vinn of the comparator COMP may decrease. The amount of change in the first input node voltage Vinn may correspond to the difference between the normal reset level RST and the signal level SIG of the pixel signal Vpx.

Thereafter, in the signal ADC period SIG_ADC, the level of the ramp signal Vramp may decrease at a predetermined slope, and the change in the level of the ramp signal Vramp is reflected in the second input node voltage Vinp. The level of the comparison result signal OUT (e.g., a second comparison result signal) output from the comparator COMP may be shifted at a time point (e.g., a second determination time point) when the level of the second input node voltage Vinp becomes the same as the level of the first input node voltage Vinn. The counter CNTR of FIG. 2A may generate a signal value (or signal code) by counting the comparison result signal OUT (e.g., a second comparison result signal) output during the signal ADC period SIG_ADC.

In the high light intensity condition (Case B), the reset level of the pixel signal Vpx has a normal reset level RST according to the pixel power voltage Vpix during the reset period RSTP, but the reset level of the pixel signal Vpx decreases due to the electric charges flowing from the photodiode PD to the floating diffusion node FD after the reset period RSTP. For example, the reset level of the pixel signal Vpx may be lowered to a blooming level.

When the reset level of the pixel signal Vpx becomes lower than the level of the clamping signal Vclp, the output voltage Vout of the first input terminal IN1 is clamped based on the clamping signal Vclp. For example, from the end time point of the reset period RSTP to the end time point of the clamping-on period CLPON (for example, the clamping period CLPP), the output voltage Vout is clamped based on the clamping signal Vclp. Accordingly, the clamping signal Vclp may be provided as the output voltage Vout to the comparator COMP during the clamping period CLPP. For example, the clamping signal Vclp may be applied to the first input node INN of the comparator COMP through the first capacitor C1.

An auto-zero operation of the comparator COMP may be performed based on the clamping signal Vclp. In the auto-zero period AZP, the first input node voltage Vinn and the second input node voltage Vinp become the same as the auto-zero level, and the difference between the level of the clamping signal Vclp and the auto-zero level may be stored in the first capacitor C1. After the clamping-on period CLPON, the clamping circuit 112 is deactivated, and accordingly, the pixel signal Vpx is provided to the first input terminal IN1. The level of the output voltage Vout may be lowered to a level (e.g., the blooming level) of the pixel signal Vpx. Accordingly, the level of the first input node voltage Vinn may be lowered to the blooming level.

Because the level of the first input node voltage Vinn is lowered to the blooming level, there is no time point at which the level of the second input node voltage Vinp is equal to the level of the first input node voltage Vinn in the reset ADC period RST_ADC. In this case, the counter CNTR may generate a maximum value (e.g., a reset full code) that a reset value may have as a reset value. The reset full code is lower than a signal full code. For example, the maximum value of pixel data DPX may be 1024 (i.e., corresponding to 10 bits), the reset full code may be 512 (i.e., corresponding to 9 bits), and the signal full code may be greater than the maximum value of pixel data DPX and less than a value obtained by adding the reset full code to the maximum value of pixel data DPX.

Because the pixel signal Vpx has already been lowered to the blooming level, even if the transfer transistor TG is turned on during the charge transfer period CTP to transfer the charges accumulated in the photodiode PD to the floating diffusion node FD, the level of the floating diffusion node FD, such as the signal level of the pixel signal Vpx, does not decrease any more, and the first input node voltage Vinn does not change.

Even if the level of the ramp signal Vramp decreases at a predetermined slope in the signal ADC period SIG_ADC, there is no time point at which the level of the second input node voltage Vinp becomes the same as the level of the first input node voltage Vinn. The counter CNTR may generate a maximum value (e.g., a signal full code) that a signal value may have as a signal value.

In this way, a reset value RV and a signal value SV may be output as maximum values, respectively, in the high light intensity condition. When pixel data DPX is generated by subtracting the reset value RV from the signal value SV, the pixel data DPX is not a maximum value, and the pixel data DPX may represent a color other than white, such as gray or black. Clamping correction (e.g., digital clamping) may be performed to correct the reset value so that the pixel data DPX may represent white.

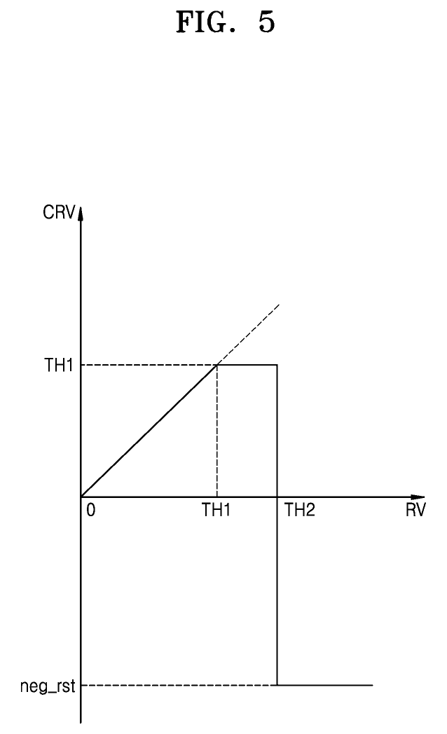

FIG. 5 is a graph illustrating a clamping correction method performed by a clamping correction circuit according to an example embodiment.

Referring to FIG. 5, the horizontal axis represents the reset value RV provided by the clamping correction circuit (141 of FIG. 1), and the vertical axis represents the corrected reset value CRV.

The clamping correction circuit 141 may correct the reset value RV based on a first threshold value TH1 and a second threshold value TH2. The first threshold value TH1 may be a saturation value representing a maximum among reset values in the normal light intensity condition, and the second threshold value TH2 may be a value close to the maximum value (e.g., reset full code) of the reset value in the counter CNTR.

The first threshold value TH1 and the second threshold value THb may be preset and adjusted according to a photographing environment. For example, the first threshold value TH1 and the second threshold value TH2 may be set higher when the illuminance of the photographing environment is higher than when the illuminance of the photographing environment is low.

The clamping correction circuit 141 may correct the reset value RV when the reset value RV is greater than or equal to the first threshold value TH1, and may not correct the reset value RV when the reset value RV is less than the first threshold value TH1. For example, the clamping correction circuit 141 may output the reset value RV as the corrected reset value CRV. When the reset value RV is greater than or equal to the first threshold value TH1 and less than the second threshold value TH2, the clamping correction circuit 141 may clip the reset value RV based on the first threshold value TH1. For example, the clamping correction circuit 141 may generate and output the first threshold value TH1 as a corrected reset value CRV. When the reset value RV is equal to or greater than the second threshold value TH2, the clamping correction circuit 141 may generate, as a corrected reset value CRV, a negative reset value neg_rst having a sign opposite of the reset value RV. Here, the negative reset value neg_rst represents a minimum negative value representable by a reset code format of the corrected reset value CRV. For example, when the reset value RV is 500 and 500 is greater than or equal to the second threshold value TH2, and the minimum negative value of the corrected reset value CRV is -520, the clamping correction circuit 141 may generate and output -520 as the corrected reset value CRV.

For example, assuming that the maximum value of the reset value RV is 512, the maximum value of the signal value SV is 1030, the minimum negative value of the corrected reset value CRV is -520, and the maximum value of the pixel data DPX is 1024, the reset value RV may be 512 and the signal value SV may be 1030, in the high light intensity condition (Case B). The clamping correction circuit 141 may generate a negative reset value corresponding to the minimum negative value (e.g., -520) as a corrected reset value CRV.

The digital CDS circuit 142 of FIG. 1 may generate pixel data DPX by subtracting the corrected reset value CRV from the signal value SV. A value obtained by subtracting -520, which is the corrected reset value CRV, from 1030, which is the signal value SV is 1550. Because the maximum value of the pixel data DPX is 1024, the pixel data DPX may be calculated as 1024 in the high light intensity condition. Because the pixel data DPX represents white, the occurrence of sun spots may be prevented.

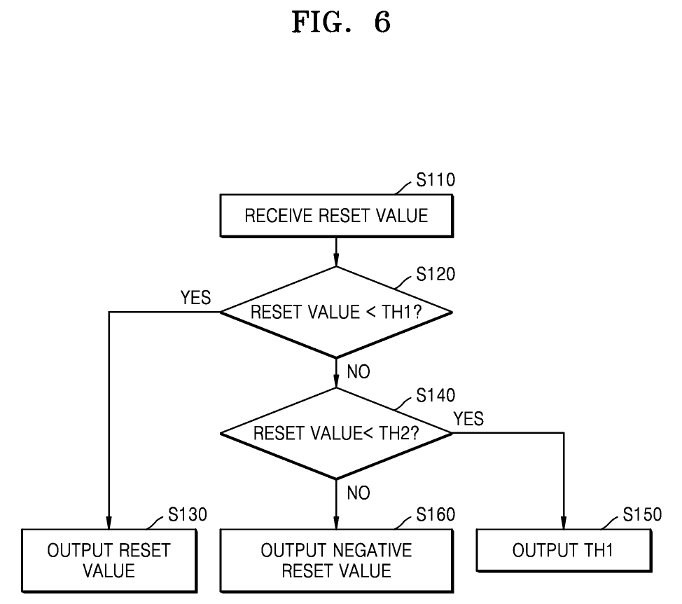

FIG. 6 is a flowchart illustrating a correcting method of a clamping correction circuit according to an example embodiment.

The correction method of FIG. 6 may be performed by the clamping correction circuit (141 of FIG. 1).

Referring to FIG. 6, a reset value may be received (S110). The reset value may be received from each pixel PX of the pixel array 110 of FIG. 1.

It may be checked whether the reset value is less than the first threshold value TH1 (S120). When the reset value is less than the first threshold value TH1, the reset value may be output as a corrected reset value (S130). For example, the reset value may be output as the corrected reset value.

When the reset value is not less than the first threshold TH1, for example, when the reset value is greater than or equal to the first threshold TH1, it may be checked whether the reset value is less than the second threshold TH2 (S140). The second threshold value TH2 is greater than the first threshold value TH1. When the reset value is less than the second threshold value TH2, the first threshold value TH1 may be output as the corrected reset value (S150). For example, the reset value may be clipped based on the first threshold value TH1.

When the reset value is not less than the second threshold TH2, for example, when the reset value is greater than or equal to the second threshold TH2, a negative reset value may be output as a corrected reset value (S160). A negative reset value may be a minimum negative value representable by a reset code format of the corrected reset value, and the negative reset value may be output as a corrected reset value.

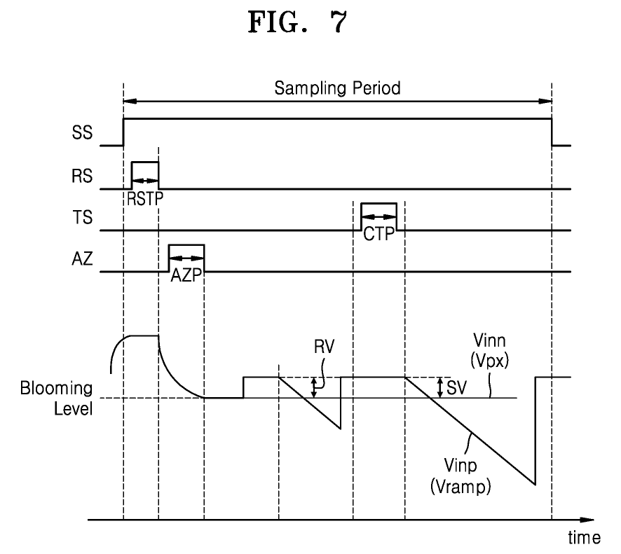

FIG. 7 is a timing diagram of a pixel in which no clamping is performed according to a first comparative example.

Referring to FIG. 7, when clamping is not performed in the high light intensity condition, a reset level of the pixel signal Vpx may be lowered to the blooming level. An auto-zero operation may be performed based on a reset level of the pixel signal Vpx in an auto-zero period AZP. A reset value RV may be generated during the reset ADC period RST_ADC. The transfer transistor TG may be turned on in response to the transfer control signal TS of the active level during the charge transfer period CTP. Electric charges of the photodiode PD may be transferred to the floating diffusion node FD. However, because the floating diffusion node FD is already saturated, the level of the pixel signal Vpx does not change. Accordingly, the signal value SV generated in the signal ADC period SIG_ADC may be the same as the reset value RV. Therefore, the pixel data DPX may be the lowest value, e.g., “0”. The lowest value of the pixel data DPX may correspond to black. Accordingly, a sun spot may occur in the image data IDATA.

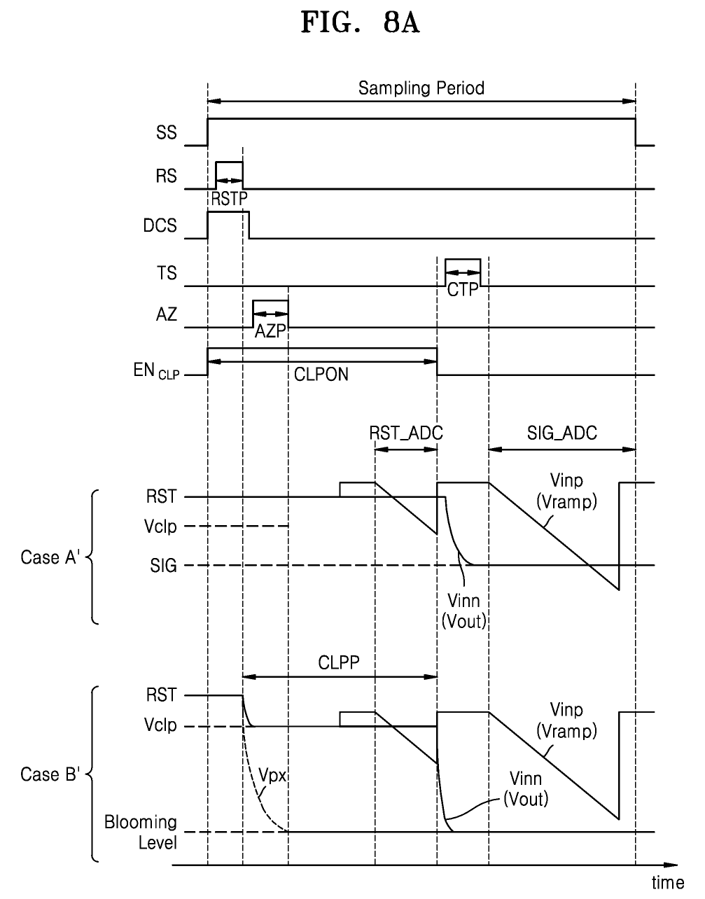

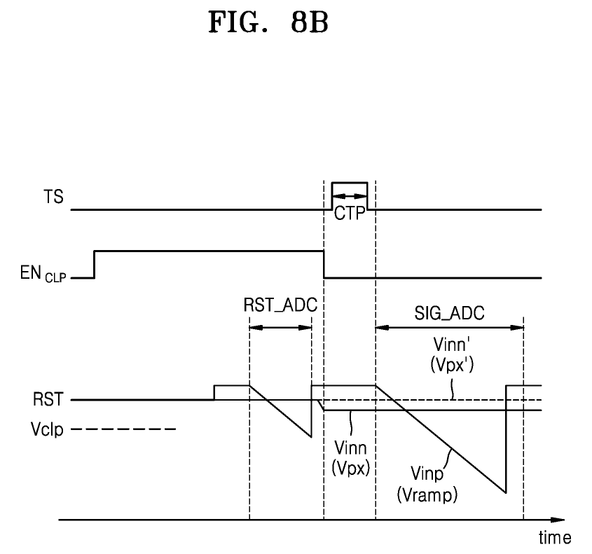

FIG. 8A is a timing diagram of a pixel in which clamping is performed during a reset ADC period according to a second comparative example, and FIG. 8B is a timing diagram showing a side effect when clamping is performed according to FIG. 8A.

Referring to FIG. 8A, according to a method of operating a pixel according to a second comparative example, a clamping-on period CLPON may overlap a reset ADC period RST_ADC as well as an auto-zero period AZP.

Because the reset level of the pixel signal Vpx is higher than the level of the clamping signal Vclp in a normal light intensity condition (Case A′), the pixel signal Vpx is provided to the comparator COMP as the output voltage Vout in the auto-zero period AZP and the reset ADC period RST_ADC. Accordingly, the voltage waveforms Vinp and Vinn of the input nodes of the comparator COMP in the normal light intensity condition (Case A′) may be the same as the voltage waveforms Vinp and Vinn of the input nodes of the comparator COMP in the normal light intensity condition (Case A) in the pixel PXa according to an example embodiment illustrated in FIG. 4.

Because the reset level of the pixel signal Vpx is lower than the level of the clamping signal Vclp after the reset period RSTP in the high light intensity condition (Case B′), the clamping signal Vclp may be provided to the first input node INN as the output voltage Vout in the auto-zero period AZP and the reset ADC period RST_ADC included in the clamping-on period CLPON. An auto-zero operation may be performed based on the level of the clamping signal Vclp. A normal reset value RV corresponding to an offset added to the ramp signal Vramp may be generated.

Because the clamping circuit 112 is deactivated during the signal ADC period SIG_ADC, the pixel signal Vpx may be provided as the output voltage Vout to the first input node INN of the comparator COMP. The first input node voltage Vinn may be lowered to a blooming level along the pixel signal Vpx. Accordingly, a signal value SV having a maximum value (signal full code) may be generated in the signal ADC period SIG_ADC.

Because the signal value SV is a maximum value and the reset value RV is a normal reset value, the pixel data DPX generated by subtracting the reset value RV from the signal value SV without a separate correction operation also has a maximum value and may represent white.

However, after the clamping circuit 112 is activated until the reset ADC period RST_ADC to provide the clamping signal Vclp, a side effect may occur as the clamping circuit 112 is deactivated.

Referring to FIG. 3, a parasitic capacitor may be formed between transistors of the clamping circuit 112, for example, between the clamping enable transistor ENX and the source follower transistor SF of the photo detecting circuit 111a, and the level shift of the clamping enable signal ENCLP at the end time point of the clamping-on period CLPON by the parasitic capacitor affects the pixel signal Vpx.

Referring to FIG. 8B, because there is no charge generated by the photodiode PD in a dark condition, the reset level and the signal level of an ideal pixel signal Vpx′ may be the same as each other. Accordingly, an ideal first input node voltage Vinn′ may be equal in both of the reset ADC period RST_ADC and the signal ADC period SIG_ADC. The reset value RV and the ideal signal value SV are the same as or similar to each other, and the pixel data DPX may have a minimum value (e.g., code values 1 to 2).

However, as shown, as the level of the clamping enable signal ENCLP is shifted from logic high to logic low at the end time point of the clamping-on period CLPON, the pixel signal Vpx changes. Accordingly, an offset is generated between the reset level and the signal level of the pixel signal Vpx, and the offset is reflected in the first input node voltage Vinn. The signal value SV is greater than the reset value RV, and the pixel data DPX may have a value corresponding to the offset (e.g., code values of 14 to 27). As the pixel data DPX has a value corresponding to an offset other than the lowest value in a dark condition, image quality degradation may occur in the image data IDATA.

However, as described above, according to the clamping method according to an example embodiment, because the shift of the level of the clamping enable signal ENCLP does not affect the pixel signal Vpx, deterioration of image data IDATA due to analog clamping may be prevented.

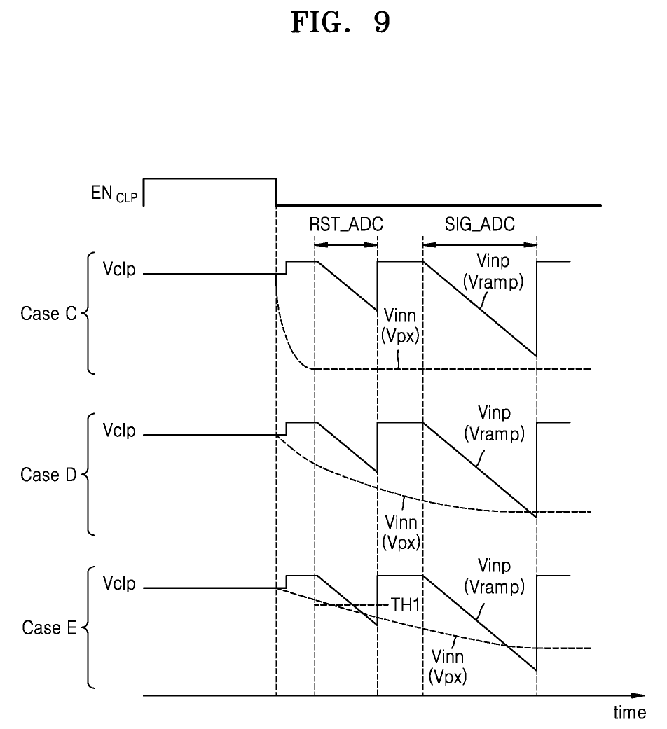

FIG. 9 is a timing diagram of a sampling period of a pixel according to an example embodiment.

Case C represents high light intensity conditions, Case D represents high-medium light intensity conditions, and Case E represents medium light intensity conditions. For example, the high-medium light intensity conditions of Case D may be brighter than the medium light intensity conditions of Case E. For example, the high light intensity conditions of Case C may be brighter than the high-medium light intensity conditions of Case D. The decrease in the reset level of the pixel signal Vpx during the large light intensity condition, the high-medium light intensity condition, and the medium light intensity condition indicates that the intensity of light incident on the pixel PX is excessively large, and thus the pixel data DPX should be calculated as a maximum value. The auto-zero operation may be performed based on the clamping signal Vclp, and after the clamp enable signal ENCLP is shifted from an active level (e.g., logic high) to an inactive level (e.g., logic low), the first input node voltage Vinn changes along with the pixel signal Vpx.

Because the reset level and the signal level of the pixel signal Vpx are lower than the level of the ramp signal Vramp during the reset ADC period RST_ADC and the signal ADC period SIG_ADC, in the high light intensity condition Case C, the reset value RV and the signal value SV may be maximum values (e.g., reset full code and signal full code), respectively, and the pixel data DPX may have a maximum value corresponding to white according to the clamping correction method described above with reference to FIGS. 5 and 6.

In the high-medium light intensity condition Case D, the pixel signal Vpx may decrease relatively more slowly than in the high light intensity condition. Because the reset level of the pixel signal Vpx is lower than the level of the ramp signal Vramp in the reset ADC period RST_ADC, the reset value RV may be a maximum value. The level of the ramp signal Vramp may be equal to the signal level of the pixel signal Vpx at the end of the signal ADC period SIG_ADC. The signal value SV may have a value close to the maximum value. The reset value RV corrected according to the clamping correction method described above may be a negative reset value neg_rst (e.g., a minimun negative value), and a value obtained by subtracting the corrected reset value CRV from the signal value SV may exceed the maximum value of the pixel data DPX. Accordingly, the pixel data DPX may have a maximum value corresponding to white.

When clamping is performed in the reset ADC period according to a second comparative example of FIG. 8A during the high-medium light intensity condition, the first input node voltage Vinn is changed along with the pixel signal Vpx after the reset ADC period RST_ADC, and a time point at which the level of the ramp signal Vramp becomes the same as the signal level of the pixel signal Vpx may be earlier than the time point shown in Case D of FIG. 9. The signal value SV is not a maximum value, and the pixel data DPX generated by subtracting the normal reset value RV from the signal value SC is not a maximum value, and may indicate gray. As described above, according to the second comparative example, the pixel data DPX may be erroneously corrected to gray instead of white.

In the medium light intensity condition Case E, the pixel signal Vpx may decrease relatively more slowly than in the high-medium light intensity condition. The level of the ramp signal Vramp may be equal to the reset level of the pixel signal Vpx at the end of the reset ADC period RST_ADC. The reset value RV may have a value close to the maximum value. The reset value RV may be greater than or equal to the first threshold value TH1.

The level of the ramp signal Vramp may be equal to the signal level of the pixel signal Vpx at the end of the signal ADC period SIG_ADC. The signal value SV may be less than the maximum value. The reset value CRV corrected according to the clamping correction method described above may be a first threshold value TH1 or a negative reset value neg_rst, and a value obtained by subtracting the corrected reset value CRV from the signal value SV may be a value close to the maximum value of the pixel data DPX. Accordingly, the pixel data DPX may have a maximum value corresponding to white or a value close to the maximum value.

When the clamping correction method according to an example embodiment is not applied, the reset value RV may be subtracted from the signal value SV to calculate the pixel data DPX. In this case, because the reset value RV is close to the maximum value and the signal value SV is less than the maximum value, the pixel data DPX may have a value significantly different from the maximum value, and accordingly, sun spots may occur in the image data including the pixel data DPX.

As described with reference to FIG. 9, according to the clamping method (analog clamping and digital clamping) according to an example embodiment, pixel data DPX is calculated to a maximum value not only during a high light intensity condition, but also during high-medium light intensity condition and medium light intensity condition, thereby preventing the occurrence of sun spots.

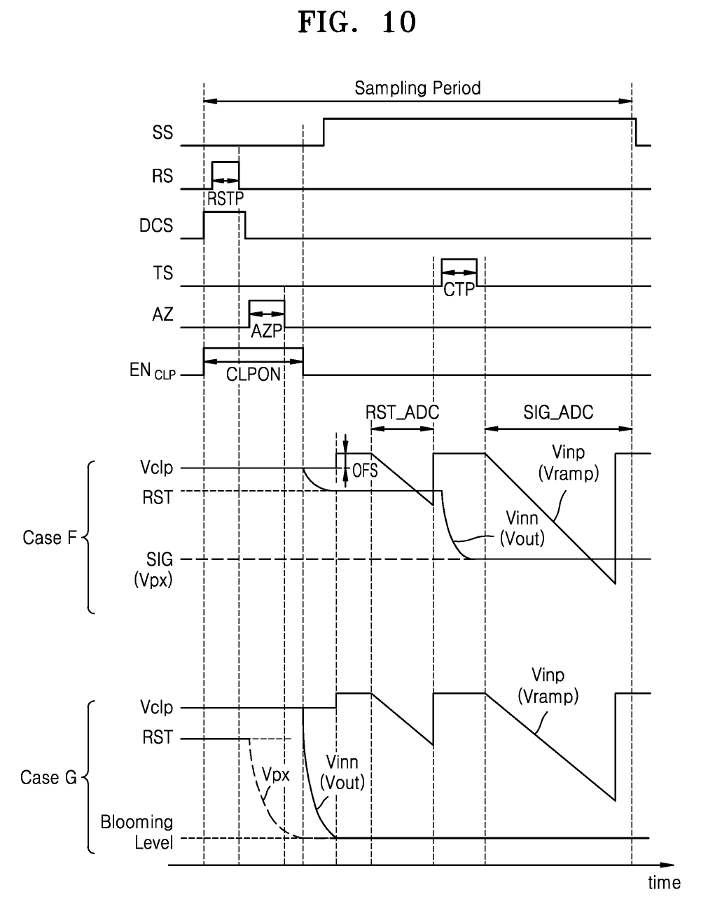

FIG. 10 is a timing diagram of a sampling period of a pixel according to an example embodiment.

FIG. 10 illustrates an example embodiment in which auto-zero is performed based on a clamping signal Vclp regardless of an optical condition. Case F represents the voltage waveforms of the comparator COMP in normal light intensity conditions, and Case G represents the voltage waveforms of the comparator COMP in high light intensity conditions. For example, the high light intensity conditions of Case G may be brighter than the normal light intensity conditions of Case F. A difference from FIG. 4 will be mainly described.

As shown in FIG. 10, a clamping signal Vclp may be higher than a normal reset level RST. During a clamping-on period CLPON, a selection signal SS is a logic low, for example, an inactive level, and accordingly, the photo detecting circuit 111a may not output the pixel signal Vpx. During the clamping-on period CLPON, the clamping signal Vclp is provided to the comparator COMP as the output voltage Vout, and an auto-zero operation may be performed based on the clamping signal Vclp.

Unlike the normal light intensity condition Case A of FIG. 4, the auto-zero operation may be performed based on the clamping signal Vclp, even in the normal light intensity condition Case F. After the clamping-on period CLPON, the pixel signal Vpx may be provided as the output voltage Vout to the comparator COMP. The level of the first input node voltage Vinn may be lowered to a normal reset level RST according to the pixel signal Vpx. In the reset ADC period RST_ADC, a reset value RV may be generated based on the difference between the normal reset level RST of the pixel signal Vpx and the level of the clamping signal Vclp and the offset OFS of the ramp signal Vramp.

Because the difference between the reset level RST and the level of the clamping signal Vclp as well as the offset OFS of the ramp signal Vramp is reflected in the reset value RV, the offset OFS of the ramp signal Vramp may be reduced. As the offset OFS of the ramp signal Vramp decreases, the settling time of the ramp signal Vramp decreases, and thus the sampling period may decrease. In addition, power consumption may be reduced, and linear characteristics of the ramp signal Vramp may be improved.

An auto-zero operation may be performed based on the clamping signal Vclp even in the high light intensity condition (Case G). Because the level of the clamping signal Vclp is higher than the normal reset level RST, the difference between the auto-zero level and the blooming level may be greater than the difference between the auto-zero level and the blooming level when the level of the clamping signal Vclp is lower than the normal reset level RST. When the difference between the auto-zero level and the blooming level is small, a time point at which the second input node voltage Vinp becomes equal to the first input node voltage Vinn may occur in the signal ADC period SIG_ADC and/or the reset ADC period RST_ADC despite the high light intensity condition, and accordingly, the sun spot removal may not be performed. However, according to an example embodiment, because the difference between the auto-zero level and the blooming level increases, a voltage margin for removing sun spots may be sufficiently secured.

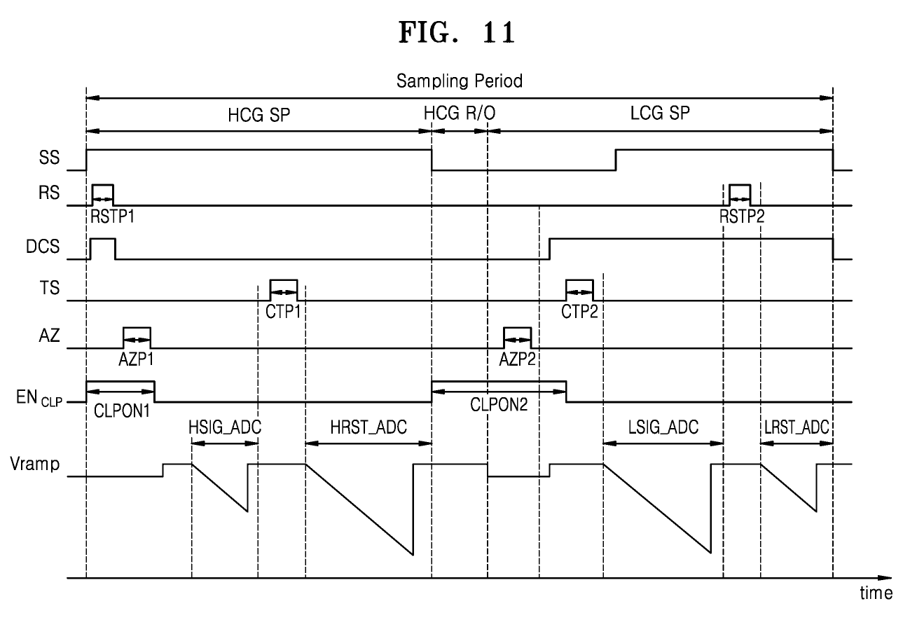

FIG. 11 is a timing diagram of a sampling period of a pixel according to an example embodiment.

Referring to FIGS. 3 and 11 together, the pixel PXa may operate in a HCG mode or an LCG mode (e.g., dual conversion mode) during the sampling period after one exposure. A reset ADC and a signal ADC should be performed in the HCG mode, and the reset ADC and the signal ADC should be performed in the LCG mode. One comparator COMP may sample the pixel signal Vpx in an R-S-S-R (Reset-Signal-Signal-Reset) readout method to perform the reset ADC and the signal ADC in the HCG mode or the LCG mode. For example, the reset ADC may be performed and then the signal ADC may be performed, during the HCG sampling period HCG SP, and then the signal ADC may be performed and then the reset ADC may be performed during the LCG sampling period LCG SP.

During the HCG sampling period HCG SP, the conversion gain control transistor DCG has an inactive level according to the conversion gain control signal DCS of the inactive level, and the pixel PXa may operate in the HCG mode. However, during the reset period RSTP1, the conversion gain control signal DCS has an active level, and the conversion gain control transistor DCG may be turned on.

The operation of the pixel PXa in the HCG sampling period HCG SP is the same as described with reference to FIG. 4. The auto-zero operation of the comparator COMP may be performed in the auto-zero period AZP1, and the clamping circuit 112 may output the clamping signal Vclp in the clamping-on period CLPON1. The clamping-on period CLPON1 may overlap or include the auto-zero period AZP and/or the reset period RSTP, and the clamping-on period CLPON1 does not overlap either of the reset ADC period HRST_ADC and the signal ADC period HSIG_ADC. In the reset ADC period HRST_ADC, the reset level of the pixel signal Vpx in the HCG mode is analog-to-digital converted to generate an HCG reset value, and after the charge transfer period CTP1, the signal level of the pixel signal Vpx in the HCG mode is analog-to-digital converted in the signal ADC period HSIG_ADC to generate an HCG signal value.

The HCG reset value and the HCG signal value may be stored in the memory 114 and then output to the pre-processing circuit (140 of FIG. 1) during the HCG readout period HCGR/O.

During the LCG sampling period LCG SP, the conversion gain control transistor DCG has an inactive level according to the conversion gain control signal DCS of the active level, and the pixel PXa may operate in the LCG mode. The conversion gain control signal DCS may be shifted from an inactive level to an active level after the auto-zero period AZP2.

The auto-zero operation of the comparator COMP may be performed in the auto-zero period AZP2, and the clamping circuit 112 may output the clamping signal Vclp in the clamping-on period CLPON2. The clamping-on period CLPON2 may include the auto-zero period AZP2. In this case, as described above with reference to FIG. 10, the level of the clamping signal Vclp may be higher than the normal reset level RST. During the clamping-on period CLPON2, the selection signal SS is an inactive level, and the photo detection circuit 111a may not output the pixel signal Vpx. The clamping signal Vclp is provided as an output voltage Vout to the first input terminal IN1, and accordingly, the auto-zero operation of the comparator COMP may be performed based on the clamping signal Vclp.

During the charge transfer period CTP2, charges accumulated in the photodiode PD may be transferred to the floating diffusion node FD, and the signal level of the pixel signal Vpx in the LCG mode may be analog-to-digital converted in the signal ADC period LSIG_ADC to generate an LCG signal value. Thereafter, during the reset period RSTP2, the reset transistor RG is turned on in response to the reset control signal RS of the active level, and thus the floating diffusion node FD may be reset based on the pixel power supply voltage Vpix. In the reset ADC period LRST_ADC, a reset level of the pixel signal Vpx in the LCG mode may be analog-to-digital converted to generate an LCG reset value. The LCG reset value and the LCG signal value may be stored in the memory 114 and then output to the pre-processing circuit (140 of FIG. 1).

When sampling is performed in the order of reset ADC after the signal ADC in the LCG sampling period LCG SP, because the reset level of the pixel signal Vpx is higher than the signal level in the normal light intensity condition, the voltage of the first input node INN, for example, the voltage of the first input node Vinn, may increase as the pixel signal Vpx increases from the signal level to the reset level.

When the auto-zero operation of the comparator COMP is performed based on the signal level of the pixel signal Vpx, there is no change in the pixel signal Vpx in the auto-zero period AZP2 and the signal ADC period LSIG_ADC, and the first input node voltage Vinn may also maintain the auto-zero level without change. Thereafter, as the pixel signal Vpx is changed from the signal level to the reset level, the first input node voltage Vinn increases by the difference between the signal level and the reset level from the auto-zero level. The first input node voltage Vinn may increase to the analog power voltage VDDA or higher, and a leakage current may occur in the fifth transistor T5 (see FIG. 3) connected to the first input node INN. As a result, a reliability problem may occur and fixed pattern noise may occur.

However, as described above, when an auto-zero operation is performed based on the clamping signal Vclp during the LCG sampling period LCG SP, the clamping signal Vclp is provided to the comparator COMP as an output voltage Vout (e.g., voltage of the first input terminal IN1), and then the pixel signal Vpx is provided to the comparator COMP as an output voltage Vout during the signal ADC period LSIG_ADC and the reset ADC period LRST_ADC. Accordingly, the first input node voltage Vinn is lowered by the difference between the level of the clamping signal Vclp and the signal level of the pixel signal Vpx from the auto-zero level before the signal ADC period LSIG_ADC, and then as the pixel signal Vpx is changed from the signal level to the reset level before the reset ADC period LRST_ADC, the first input node voltage Vinn is increased by the difference between the signal level and the reset level. As the pixel signal Vpx is changed from the signal level to the reset level, even if the first input node voltage Vinn is increased, the first input node voltage Vinp is not increased beyond the analog power voltage VDDA because the first input node voltage Vinn is lowered from the auto-zero level before the first input node voltage Vinn is increased and then increased. Therefore, reliability problems and the occurrence of fixed pattern noise may be prevented.

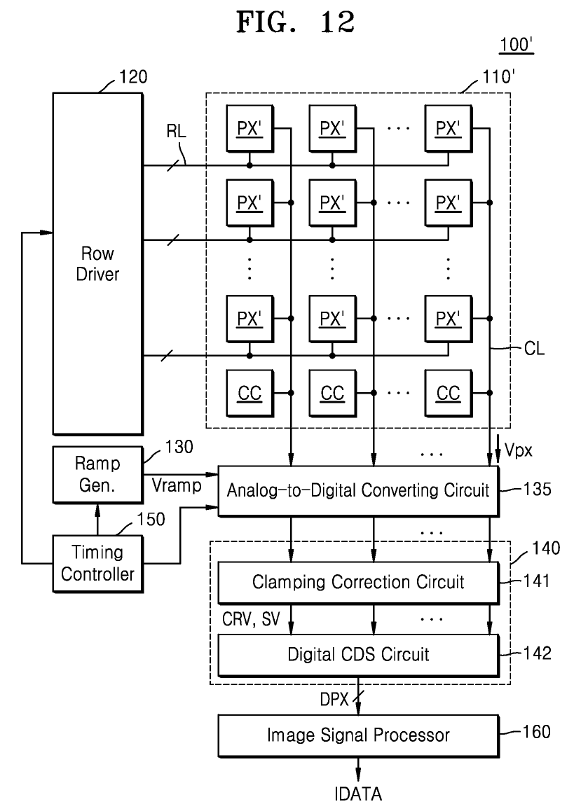

FIG. 12 is a circuit diagram illustrating an image sensor according to an example embodiment.

Referring to FIG. 12, an image sensor 100′ may include a pixel array 110′, a row driver 120, a ramp signal generator 130, an analog-to-digital converting circuit 135, a pre-processing circuit 140, and an image signal processor 160. The pre-processing circuit 140 may include a clamping correction circuit 141 and a digital CDS circuit 142. A difference from the image sensor 100 of FIG. 1 will be described.

The pixel array 110′ may include a plurality of pixels PX′ arranged in a matrix, a plurality of row lines RL, a plurality of column lines CL, and a plurality of clamping circuits CC.

Unlike the pixel PX of FIG. 1, the pixel PX′ does not include a clamping circuit (112 in FIG. 1), an ADC (113 in FIG. 1), and a memory (114 in FIG. 1), and the pixel PX′ may include a photo detecting circuit (111a in FIG. 2A, and 111b in FIG. 2B). However, the clamping circuit CC may be connected to a corresponding column line CL among the plurality of column lines CL, and a plurality of clamping circuits CC may be connected to the plurality of column lines CL, respectively. A plurality of pixels PX′ may be sequentially driven in a row unit according to the rolling shutter method, and may sequentially output pixel signals Vpx.

The analog-to-digital converting circuit 135 may include a plurality of analog-to-digital converters (ADCs), and the plurality of ADCs may convert a reset level and a signal level of a pixel signal Vpx received through a corresponding column line CL among the plurality of column lines CL into a reset value and a signal value. The plurality of ADCs may initially perform auto-zero operations for each readout period of each row being driven, and the clamping circuit CC may output a clamping signal Vclp in the auto-zero period. In this regard, analog clamping may be performed in the auto-zero period as described above.

The operation of the pre-processing circuit 140 is the same as described with reference to FIG. 1. The clamping correction circuit 141 may correct the received reset value based on a threshold value (e.g., a first threshold value TH1 and a second threshold value TH2), and may output a corrected reset value. The digital CDS circuit 142 may generate pixel data DPX based on the signal value and the corrected reset value.

Operations of the pre-processing circuit 140, the ramp signal generator 130, the timing controller 150, and the image signal processor 160 are the same as those described with reference to FIG. 1, and thus redundant descriptions thereof will be omitted.

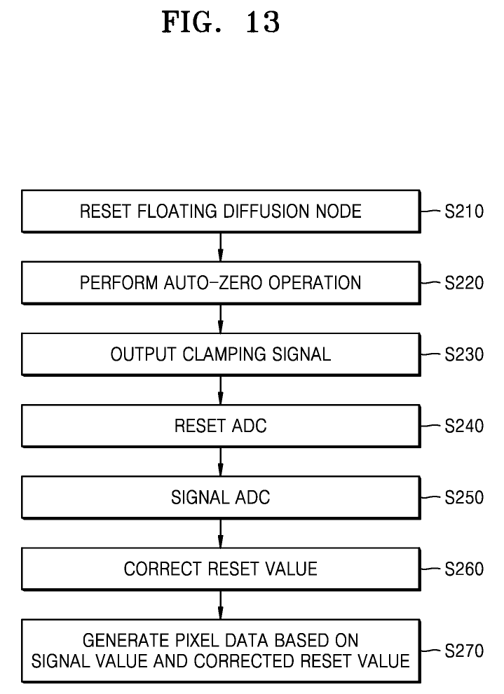

FIG. 13 is a flowchart illustrating an operation method of operating an image sensor according to an example embodiment.

The operation method of FIG. 13 may be performed by the image sensor 100 of FIG. 1 or the image sensor 100′ of FIG. 12.

Referring to FIGS. 1 and 11, during the reset period, the photo detecting circuit 111 of the pixel PX may reset the floating diffusion node by applying a pixel power voltage to the floating diffusion node (S210). The ADC 113 may perform the auto-zero operation in the auto-zero period (S220). In the clamping-on period, the clamping circuit 112 may output the clamping signal Vclp (S230). The clamping-on period may include an auto-zero period or overlap an auto-zero period. The end time point of the clamping-on period may be after the end time point of the auto-zero period. The clamping signal Vclp may be provided as an input terminal of the ADC 113. When the reset level of the pixel signal Vpx is excessively low and is lower than the level of the clamping signal Vclp, such as during the high light intensity condition, the auto-zero operation may be performed based on the clamping signal Vclp.

In an example embodiment, the level of the clamping signal Vclp may be set higher than the normal reset level of the pixel signal Vpx, and an auto-zero operation may be performed based on the clamping signal Vclp not only during a high light intensity condition but also during a normal light intensity condition. In this case, the output of the pixel signal Vpx from the photo detecting circuit 111 may be blocked.

In the reset ADC period, the ADC 113 may convert a reset level of the pixel signal received through the input node to a reset value RV (S240). The ADC 113 may generate a reset value RV by comparing a reset level of the pixel signal with the ramp signal Vramp.

In the signal ADC period, the ADC 113 may convert the signal level of the pixel signal received through the input node into a signal value SV (S250). The ADC 113 may generate the signal value SV by comparing the signal level of the pixel signal with the ramp signal Vramp.

The reset value RV and the signal value SV may be provided to the pre-processing circuit 140, and the clamping correction circuit 141 may correct the reset value RV (S260). When the reset value RV is greater than or equal to a first threshold value and less than a second threshold value, the clamping correction circuit 141 may generate a corrected reset value by clipping the reset value RV based on the first threshold value. When the reset value RV is greater than or equal to the second threshold value, the clamping correction circuit 141 may generate a negative reset value (e.g., a minimum negative value) as a corrected reset value. When the reset value RV is less than the first threshold (e.g., a reset value in a normal light intensity condition), the clamping correction circuit 141 may output the reset value RV as a corrected reset value. In this regard, the clamping correction circuit 141 may not correct the reset value RV.

The digital CDS circuit 142 may generate pixel data DPX based on the signal value and the corrected reset value (S270). The digital CDS circuit 142 may generate the pixel data DPX by subtracting the corrected reset value from the signal value.

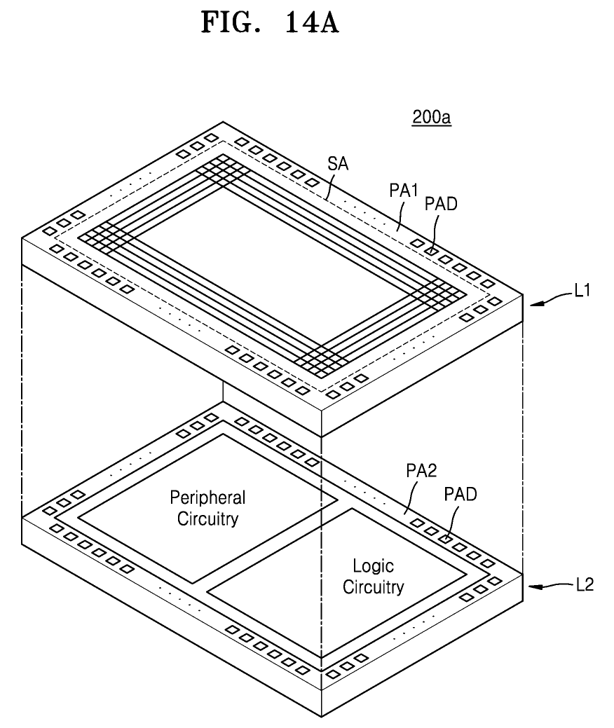

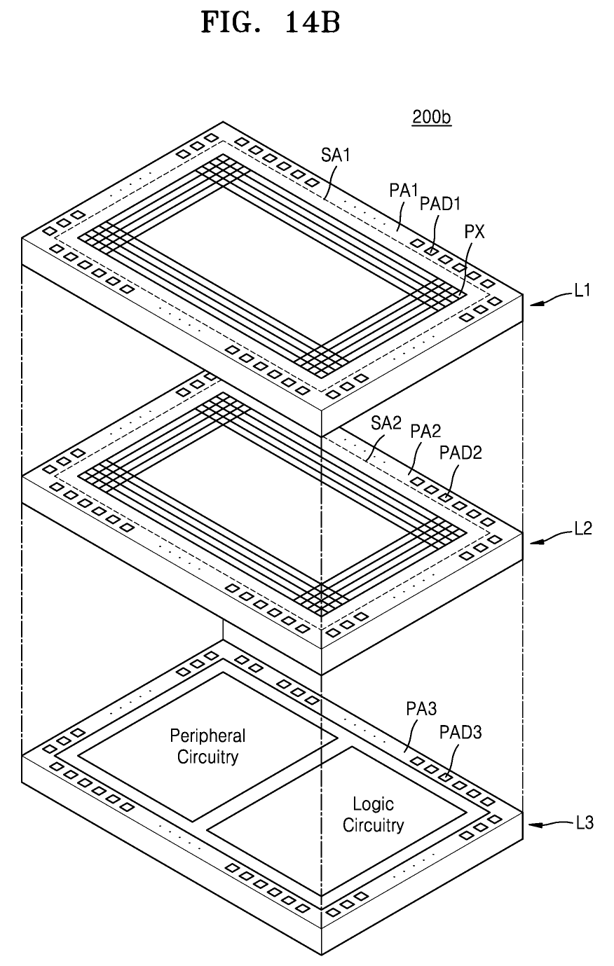

FIGS. 14A and 14B are perspective views illustrating respective stack structures of image sensors according to example embodiments.

Referring to FIG. 14A, an image sensor 200a may include a plurality of layers to be stacked, for example, a first layer L1 and a second layer L2. The first layer L1 and the second layer L2 may be manufactured through different semiconductor processes or may be manufactured from different semiconductor wafers. In an example embodiment, the first layer L1 and the second layer L2 may be formed on a semiconductor substrate or a semiconductor chip.

The first layer L1 may include a sensing area SA in which a plurality of pixels PX of the pixel array 110 or 110’ are arranged and a first pad area PA1. A plurality of pads PAD are arranged in the first pad area PA1, and the plurality of pads PAD of the first layer L1 may be electrically connected to a plurality of pads PAD of the second pad area PA2 of the second layer L2 through vias, contacts, or the like.

A peripheral circuitry and a logic circuitry of the image sensor 200a may be formed in the second layer L2. For example, a peripheral circuitry may include a row driver (120 in FIG. 1), a ramp signal generator (130), and a logic circuitry may include a pre-processing circuit (140 in FIG. 1), an image signal processor (160), and a timing controller (150). In some example embodiments, the peripheral circuitry may include a row driver (120 in FIG. 1), a ramp signal generator (130), and an ADC circuit (135 in FIG. 12).

Referring to FIG. 14B, an image sensor 200b may include a plurality of layers to be stacked, for example, a first layer L1, a second layer L2, and a third layer L3. A pixel array (110 of FIG. 1 or 100’ of FIG. 13) may be formed in each of the first layer L1 and the second layer L2, and a peripheral circuitry and a logic circuitry may be formed in the third layer L3.

The first layer L1 may include a first sensing area SA1 in which a plurality of pixels PX of the pixel array 110 or 110’ are arranged and a first pad area PA1. A plurality of pads PAD1 are arranged in the first pad area PA1, and the plurality of pads PAD1 of the first layer L1 may be electrically connected to a plurality of pads PAD2 of the second pad area PA2 of the second layer L2 through vias, contacts, or the like. In an example embodiment, the first layer L1 may be connected to the second layer L2 in a copper to copper bonding manner.

The second layer L2 may include a second sensing area SA2 in which a plurality of pixels PX are arranged and a second pad area PA2. A plurality of pads PAD2 are arranged in the second pad region PAD2, and the plurality of pads PAD2 of the second layer L2 may be electrically connected to a plurality of pads PAD3 of the third layer L3 through vias, contacts, and the like.

In an example embodiment, a photo detecting circuit 111, a clamping circuit 112, and a current source 115 of each of the plurality of pixels PX may be formed in the first sensing area SA1 of the first layer L1, and an ADC 113 and a memory 114 of each of the plurality of pixels PX may be formed in the second sensing area SA2 of the second layer L2.

A peripheral circuitry and a logic circuitry of the image sensor 100 or 100’ may be formed in the third layer L3. The peripheral circuitry and the logic circuitry may be electrically connected to the plurality of pads PAD2 of the second layer L2 through a plurality of pads PAD3 arranged in the third pad area PA3.

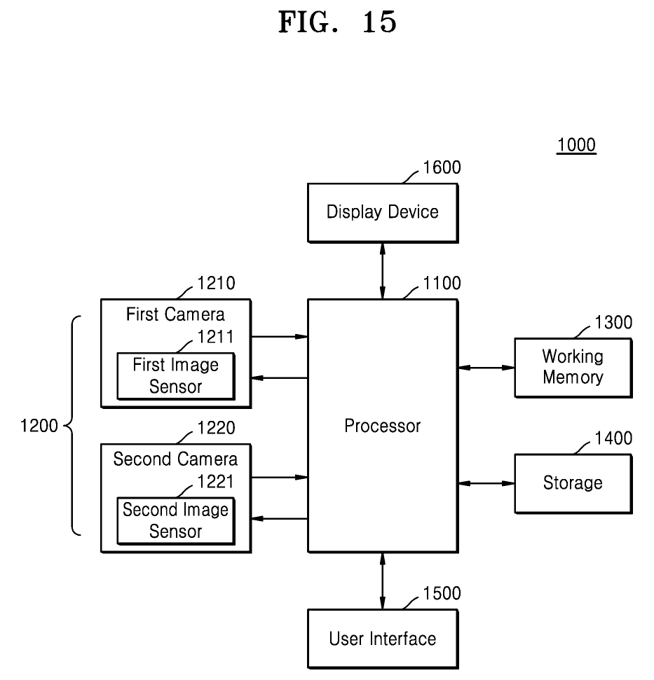

FIG. 15 is a block diagram illustrating an electronic device including an image sensor according to an example embodiment.

An electronic device 1000 may include an imaging or light sensing function, and for example, the electronic device 1000 may be a mobile terminal.

The electronic device 1000 may include a processor 1100, a camera module 1200, a display device 1600, a working memory 1300, a storage 1400, and a user interface 1500. The electronic device 1000 may further include other general-purpose configurations, for example, a communication module, a sensor module, and the like.

The processor 1100 may be implemented as a system on chip (SoC) that controls the overall operation of the electronic device 1000 and drives an application program, an operating system, and the like. In an example embodiment, the processor 1100 may be an application processor.

The processor 1100 may provide, to the display device 1600, image data provided from the camera module 1200 or may store the image data in the storage 1400. In an example embodiment, the application processor 1100 may include an image processing circuit, and the image processing circuit may perform image processing on image data received from the camera module 1200. For example, the image processing circuit may perform image processing such as 3A adjustment (auto-focus correction, auto-white balance, auto-exposure), sharpening, gamma control, resolution scaling (video/preview), and demosaic HDR processing.

The camera module 1200 may include a plurality of cameras, for example, a first camera 1210 and a second camera 1220. The first camera 1210 and the second camera 1210 may include image sensors 1211 and 1221, respectively. At least one of the first image sensor 1211 and the second image sensor 1221 (e.g., the first image sensor 1211) may be implemented as the image sensors 100 and 100′ described with reference to FIGS. 1 to 13. The first image sensor 1211 may perform analog clamping and digital clamping as described with reference to FIGS. 1 to 13. The clamping voltage may be provided to the input node of the ADC during the auto-zero period, and the clamping voltage may not be provided to the input node of the ADC during the reset ADC period and the signal ADC period. In addition, when the reset value is greater than or equal to the first threshold value, pixel data may be generated based on the corrected reset value. The reset value may be corrected to generate a corrected reset value. Accordingly, the occurrence of sun spots in the image data during the high light intensity condition may be prevented, and the occurrence of side effects due to clamping in the normal condition may usually be blocked, thereby improving the image quality of the image.

The processor 1100 may transmit, to the first image sensor 1211 and the second image sensor 1221, sensor control signals for controlling operations of the first image sensor 1211 and the second image sensor 1221. The sensor control signals may include, for example, setting values and configuration data for selecting an operation mode, a shuttering mode, and the like of the first image sensor 1211 and the second image sensor 1221. For example, the configuration data may include an exposure time setting value, an analog gain, a digital gain, a lens shading compensation value, a crosstalk coefficient, a frame rate setting value, and the like. Transmission of the sensor control signals may be performed based on, for example, an interface based on an inter-integrated circuit (I2C).

The first image sensor 1211 and the second image sensor 1221 may operate based on received sensor control signals. For example, the first image sensor 1211 may receive illuminance information around the electronic device 1000 from the processor 1100, and set and adjust thresholds (e.g., first and second thresholds) used to compensate for clamping according to the illuminance information. For example, the first image sensor 1211 may set a threshold value higher as the ambient illuminance is higher and set a threshold value lower as the ambient illuminance is lower.

The first image sensor 1211 and the second image sensor 1221 may transmit image data or signal-processed image data to the processor 1100. The transmission of the image data may be performed using, for example, a camera serial interface (CSI) based on a MIPI, but example embodiments are not limited thereto.

The working memory 1300 may be implemented as a volatile memory such as dynamic random access memory (DRAM), static RAM (SRAM), or a non-volatile resistive memory such as ferroelectric RAM (FeRAM), resistive RAM (RRAM), and phase-change RAM (PRAM). The working memory 1300 may store programs and/or data processed or executed by the application processor 1100.

The storage 1400 may be implemented as a non-volatile memory device such as an NAND flash, a resistive memory, or the like, and for example, the storage 1400 may be provided as a memory card (e.g., multimedia card (MMC), embedded MMC (eMMC), secure digital (SD) card, micro SD), or the like. The storage 1400 may store image data provided from the camera module 1200.

The user interface 1500 may be implemented as various devices capable of receiving a user input such as a keyboard, a curtain key panel, a touch panel, a fingerprint sensor, and a microphone. The user interface 1500 may receive a user input and provide, to the processor 1100, a signal corresponding to the received user input.

According to an aspect of an example embodiment, the photo detecting circuit may block output of the pixel signal in the auto-zero period.

According to an aspect of an example embodiment, the ADC may include a comparator configured to receive the pixel signal and a ramp signal, compare the pixel signal with the ramp signal, and output a comparison result signal. During the auto-zero period, an input node and an output node of the comparator may be connected to each other, and the auto-zero operation may be performed based on the clamping signal.

According to an aspect of an example embodiment, the pre-processing circuit may be configured to, based on the reset value being less than a first threshold value, generate the pixel data by subtracting the reset value from the signal value, based on the reset value being greater than or equal to the first threshold value, generate the pixel data by correcting the reset value and subtracting the corrected reset value from the signal value, based on the reset value being greater than or equal to the first threshold value and less than a second threshold value that is greater than the first threshold value, clip the reset value based on the first threshold value, and based on the reset value being equal to or greater than the second threshold value, correct the reset value by changing the sign of the reset value.

While example embodiments have been particularly shown and described, it will be understood that various changes in form and details may be made therein without departing from the spirit and scope of the following claims.

What is claimed is:

1. An image sensor comprising:
a pixel array comprising a plurality of pixels arranged in a matrix, wherein at least one of the plurality of pixels comprises:
a photo detecting circuit configured to output a pixel signal corresponding to a signal level and a reset level based on a received optical signal;
an analog-to-digital converter (ADC) comprising an input terminal configured to receive the pixel signal, wherein the ADC is configured to generate a reset value and a signal value by converting the pixel signal into an analog-to-digital converted signal; and
a clamping circuit configured to provide a clamping signal to the input terminal of the ADC during an auto-zero period in which the ADC performs an auto-zero operation;
a clamping correction circuit configured to generate a corrected reset value by correcting the reset value provided from the pixel array based on a threshold value; and
a digital correlated double sampling (CDS) circuit configured to generate pixel data based on the corrected reset value and the signal value provided from the pixel array.

2. The image sensor of claim 1, wherein the clamping circuit is further configured to be disabled during a reset analog-to-digital conversion period and a signal analog-to-digital conversion period during which the ADC generates the reset value and the signal value, respectively, based on the pixel signal, and
wherein the reset analog-to-digital conversion period and the signal analog-to-digital conversion period are after the auto-zero period.

3. The image sensor of claim 1, wherein the ADC comprises a comparator circuit configured to compare the pixel signal with a ramp signal, and output a comparison result signal, and
wherein during the auto-zero period, an input node and an output node of the comparator circuit are connected, and a voltage of the input node of the comparator circuit is set to an auto-zero level.

4. The image sensor of claim 3, wherein, the ADC is further configured to, based on a level of the pixel signal being lower than a level of the clamping signal during the auto-zero period, perform the auto-zero operation based on the level of the clamping signal.

5. The image sensor of claim 1, wherein the clamping correction circuit is further configured to, based on the reset value being greater than or equal to a first threshold value, output, as the corrected reset value, a negative reset value corresponding to a minimum negative value representable by a reset code format of the corrected reset value.

6. The image sensor of claim 5, wherein the clamping correction circuit is further configured to, based on the reset value being greater than or equal to a second threshold value and less than the first threshold value, output the second threshold value as the corrected reset value, and the second threshold value is less than the first threshold value.

7. The image sensor of claim 1, wherein a level of the clamping signal is higher than the reset level of the pixel signal.

8. The image sensor of claim 7, wherein the photo detecting circuit is further configured to block output of the pixel signal during the auto-zero period.

9. The image sensor of claim 8, wherein the ADC is further configured to perform the auto-zero operation based on the clamping signal.

10. The image sensor of claim 1, wherein each of at least one of the plurality of pixels further comprises a memory configured to store the reset value and the signal value, and
wherein reset values and signal values are output in a row unit from the plurality of pixels in the pixel array.

11. An image sensor comprising
a pixel array comprising a plurality of pixels arranged in a matrix, wherein at least one of the plurality of pixels comprises a photo detecting circuit configured to output a pixel signal corresponding to a signal level and a reset level based on a received optical signal, an analog-to-digital converter (ADC) configured to generate a reset value and a signal value by converting the pixel signal into an analog-to-digital converted signal, and a clamping circuit that provides a clamping signal to the ADC, and wherein the pixel signal and the clamping signal are received through an input terminal of the ADC; and
a clamping correction circuit configured to, based on the reset value received from the pixel array being greater than or equal to a first threshold value and less than a second threshold value, output the first threshold value as a corrected reset value, and based on the reset value being greater than or equal to the second threshold value, output, as the corrected reset value, a negative reset value corresponding to a minimum negative value representable by a reset code format of the corrected reset value.

12. The image sensor of claim 11, wherein the ADC comprises a comparator circuit configured to receive the pixel signal and a ramp signal, compare the pixel signal with the ramp signal, and output a comparison result signal,
wherein an input node and an output node of the comparator circuit are connected to set a voltage of the input node of the comparator circuit to an auto-zero level, during an auto-zero period, and
wherein the clamping circuit is enabled in the auto-zero period to provide the clamping signal to the input terminal of the ADC.

13. The image sensor of claim 12, wherein a level of the clamping signal is higher than the reset level of the pixel signal.

14. The image sensor of claim 13, wherein the photo detecting circuit is further configured to block output of the pixel signal during the auto-zero period.

15. The image sensor of claim 11, wherein the pixel array is formed in a first layer and a second layer that are vertically stacked, the photo detecting circuit and the clamping circuit are formed on the first layer, and the ADC is formed on the second layer.

16. A method of operating an image sensor including a plurality of pixels configured to sense an optical signal, wherein at least one of the plurality of pixels includes a photo detecting circuit, an analog-to-digital converter (ADC), and a clamping circuit, and wherein the method comprises:
applying, by the photo detecting circuit, a first power supply voltage to a floating diffusion node in a first period to reset the floating diffusion node;
performing, by the ADC, an auto-zero operation in a second period;
providing, by the clamping circuit, a clamping voltage to an input terminal of the ADC in a third period including the second period;
converting, by the ADC, a pixel signal to a reset value, wherein the pixel signal is received from the photo detecting circuit through the input terminal in a fourth period after the third period;
converting, by the ADC, the pixel signal to a signal value, in a fifth period after the third period;
correcting, by the ADC, the reset value based on a first threshold value to generate a corrected reset value; and
generating, by the ADC, pixel data by subtracting the corrected reset value from the signal value.

17. The method of claim 16, further comprising disabling the clamping circuit during the fourth period and the fifth period.

18. The method of claim 16, wherein the correcting of the reset value comprises:
based on the reset value being greater than or equal to the first threshold value and less than a second threshold value that is greater than the first threshold value, providing, by the ADC, the first threshold value as the corrected reset value; and
based on the reset value being equal to or greater than the second threshold value, providing, by the ADC, as the corrected reset value, a negative reset value corresponding to a minimum negative value representable by a reset code format of the corrected reset value.

19. The method of claim 16, wherein a level of the clamping voltage is higher than a reset level of the floating diffusion node.

20. The method of claim 19, further comprising blocking an output of the photo detecting circuit in the third period, wherein the auto-zero operation is performed by the ADC based on a clamping signal provided by a clamping correction circuit.
